(19) United States
(12) Patent Application Publication
(10) Pub. No.: US 2026/0367542 A1
(43) Pub. Date: Nov. 19, 2026

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: KENTARO TANAKA, Shizuoka (JP); TAICHI SATO, Shizuoka (JP); NAO HIGUCHI, Shizuoka (JP); FUMIYUKI HIYAMA, Shizuoka (JP); SHUNTARO WATANABE, Kanagawa (JP); TSUTOMU NISHIDA, Shizuoka (JP)

(21) Appl. No.: 19/721,921

(22) Filed: Jun. 26, 2026

Related U.S. Application Data
(63) Continuation of application No. PCT/JP2024/044537, filed on Dec. 17, 2024.

(30) Foreign Application Priority Data
Dec. 26, 2023 (JP) 2023-219761

(51) Int. Cl. G03G 5/147; G03G 5/047; G03G 5/087; G03G 15/22; G03G 21/18

(52) U.S. Cl. CPC G03G 5/14704; G03G 5/047; G03G 5/087; G03G 15/22; G03G 21/1814

(57) ABSTRACT

The present disclosure is an electrophotographic photosensitive member, wherein when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy 70≤(S1+S2)≤95 and 0.8≤(S1/S2)≤2.0; when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy 50≤L1≤300 and 2.0≤L1/L2≤10.0.

### CROSS-REFERENCE TO RELATED APPLICATIONS

This application is a Continuation of International Patent Application No. PCT/JP2024/044537, filed Dec. 17, 2024, which claims the benefit of Japanese Patent Application No. 2023-219761 filed Dec. 26, 2023, both of which are hereby incorporated by reference herein in their entirety.

### BACKGROUND

### Field of the Technology

The present disclosure relates to an electrophotographic photosensitive member, and a process cartridge and an electrophotographic apparatus which include the electrophotographic photosensitive member.

### Description of the Related Art

Conventionally, in an electrophotographic type or an electrostatic recording type of image forming apparatus, a corona charging apparatus has been used as a charging treatment unit for the electrophotographic photosensitive member such as the electrophotographic photosensitive member or an electrostatic recording dielectric member. In recent years, a contact charging type of apparatus has been put into practical use, which brings a charging member to which a voltage is applied into contact with the electrophotographic photosensitive member, and thereby charges the electrophotographic photosensitive member, because the apparatus has advantages such as low ozone and low power consumption.

In particular, a roller charging system which uses a charging roller as the charging member is preferably used from the viewpoint of charging stability. In the contact charging apparatus of the roller charging system, an elastic roller having a medium resistance as the charging member is brought into pressure contact with the electrophotographic photosensitive member, a voltage is applied to the elastic roller, and thereby, the electrophotographic photosensitive member is submitted to charging treatment. Specifically, the electrophotographic photosensitive member is charged by an electric discharge from the charging member, and accordingly the charging is started according to Paschen's law by application of a voltage equal to or higher than a certain threshold voltage.

Also, in such a roller charging system, a discharge phenomenon is used in order to apply the voltage to the electrophotographic photosensitive member, and accordingly discharge products are generated and the surface of the electrophotographic photosensitive member is deteriorated, though the generation and the deterioration are minor compared to a charging system which uses the corona charging apparatus. The discharge products and the deteriorated surface of the electrophotographic photosensitive member cause reduced electric resistance, particularly under a high-temperature and high-humidity environment, whereby a surface potential necessary for image formation is not formed on the electrophotographic photosensitive member, and accordingly, it is sometimes difficult to develop a desired image by the developing member.

In order to solve this problem, a configuration is generally used in which printing is continued while the discharge products on the surface of the electrophotographic photosensitive member and the deteriorated surface of the electrophotographic photosensitive member are scraped little by little, and thereby the discharge products and the deteriorated surface of the electrophotographic photosensitive member are scraped off at the same time. Specifically, the surface of the electrophotographic photosensitive member is scraped off by a cleaning blade which is arranged in contact with the electrophotographic photosensitive member and cleans a developing agent remaining on the surface of the electrophotographic photosensitive member, the charging member, or the developing member.

However, in recent years, from the viewpoint of reducing the frequency of maintenance and improving usability, an increase in the number of printable sheets has been required, and along with this, the life of the electrophotographic photosensitive member needs to be extended. In other words, in the electrophotographic photosensitive member in an image forming apparatus having a long life, it is difficult to use the countermeasure in which the surface of the electrophotographic photosensitive member is continuously scraped over a long period of use (throughout the life).

For this reason, an injection charging system which is not accompanied by the discharge phenomenon has been proposed as a countermeasure against the discharge products and the deterioration of the surface of the electrophotographic photosensitive member as such a system does not depend on the scraping of the surface of the electrophotographic photosensitive member. In order to realize electric charge injection from a charging member, the electrophotographic photosensitive member which is used in the image forming apparatus of the injection charging system is required to be designed so that an electroconductive material is used for the surface of the electrophotographic photosensitive member.

For example, Japanese Patent Laid-Open No. H11-249493 proposes a technique of improving the injection charging property by incorporating an electroconductive powder into the surface of the electrophotographic photosensitive member and using the electroconductive powder having a particle diameter equal to or larger than the film thickness of the surface layer and thereby exposing the electroconductive powder from the surface layer.

However, there has been still room for improvement when the electrophotographic photosensitive member of Japanese Patent Laid-Open No. H11-249493 is used in an image forming apparatus to which a long life is required. For example, it is necessary to improve the image forming apparatus having a long life so as to suppress the generation of a spot image occurring therein which is caused by contamination of the surface of the electrophotographic photosensitive member.

Therefore, the present disclosure is directed to providing an electrophotographic photosensitive member that can withstand use in an image forming apparatus having a long life by using two types of particles and creating an appropriate surface state in the surface layer of the electrophotographic photosensitive member, in designing of a surface layer of the electrophotographic photosensitive member.

### SUMMARY

The present disclosure in the following achieves the above provision.

Specifically, the present disclosure provides an electrophotographic photosensitive member having a surface layer, wherein
the surface layer includes a binder resin, a first particle and a second particle;
the surface of the surface layer has a convex part derived from the first particle and a convex part derived from the second particle;
when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2),

70≤(S1+S2)≤95 (1), and

0.8≤(S1/S2)≤2.0 (2); and
when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy the following expression (3) and the following expression (4),

50≤L1≤300 (3), and

2.0≤L1/L2≤10.0 (4), wherein
the first particle includes any one or more selected from the group consisting of a metal oxide particle, a metal particle and carbon black, and
the second particle includes a silica particle.

In addition, the present disclosure provides a process cartridge that integrally supports the above electrophotographic photosensitive member and at least one unit selected from the group consisting of a charging unit, a developing unit and a cleaning unit, and is freely attachable to and detachable from a main body of an electrophotographic apparatus.

In addition, the present disclosure provides the electrophotographic apparatus including the above electrophotographic photosensitive member, the charging unit, an exposing unit, the developing unit, and a transfer unit.

### Present Disclosure

Features of the present disclosure will become apparent from the following description of embodiments with reference to the attached drawings.

### BRIEF DESCRIPTION OF THE DRAWINGS

FIG. 1 illustrates a schematic view of an example of a cross-sectional structure of an electrophotographic photosensitive member according to the present disclosure.

FIG. 2 illustrates a schematic view of an example of a cross-sectional structure of a surface layer of the electrophotographic photosensitive member according to the present disclosure.

FIG. 3 illustrates a schematic view illustrating an example of a schematic configuration of an electrophotographic apparatus having a process cartridge which includes an electrophotographic photosensitive member and a charging unit.

FIG. 4 illustrates a schematic view illustrating an example of a unit measuring range in a cross section of a surface layer of the electrophotographic photosensitive member according to the present disclosure.

FIG. 5 illustrates a schematic view for describing measurement of a film thickness and exposure height of particle in a cross section of the surface layer of the electrophotographic photosensitive member according to the present disclosure.

FIG. 6 illustrates an STEM image of niobium-doped titanium oxide included in the surface layer of the electrophotographic photosensitive member according to the present disclosure.

FIG. 7 illustrates a schematic view for describing an EDS analysis by STEM.

### DESCRIPTION OF THE EMBODIMENTS

### One Embodiment

One embodiment of the present disclosure is directed to an electrophotographic photosensitive member.

As a result of intensive studies, the inventors of the present disclosure have found a method for designing a surface layer of an electrophotographic photosensitive member, which suppresses the contamination of the electrophotographic photosensitive member, which occurs in an image forming apparatus having a long life. This electrophotographic photosensitive member can be used not only in an image forming apparatus of an injection charging system, but also in an image forming apparatus of a discharge charging system.

Specifically, the electrophotographic photosensitive member of the present disclosure provides an electrophotographic photosensitive member having a surface layer, wherein
the surface layer includes a binder resin, a first particle and a second particle;
the surface of the surface layer has a convex part derived from the first particle and a convex part derived from the second particle;
when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2),

70≤(S1+S2)≤95 (1), and

0.8≤(S1/S2)≤2.0 (2); and
when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy the following expression (3) and the following expression (4),

50≤L1≤300 (3), and

2.0≤L1/L2≤10.0 (4), wherein
the first particle includes any one or more selected from the group consisting of a metal oxide particle, a metal particle and carbon black, and
the second particle includes a silica particle.

Hereinafter, preferable embodiments of the present disclosure will be described.

### [Electrophotographic Photosensitive Member]

The electrophotographic photosensitive member of the present disclosure has a surface layer. It is preferable for the electrophotographic photosensitive member of the present disclosure to include a support, and a charge generating layer, a charge transporting layer and a particle-containing surface layer which are provided on the support. The electrophotographic photosensitive member according to the present disclosure can be used as a cylindrical electrophotographic photosensitive member in which the charge generating layer, the charge transporting layer and the surface layer are formed on a cylindrical support, but can also have a form of a belt or a sheet.

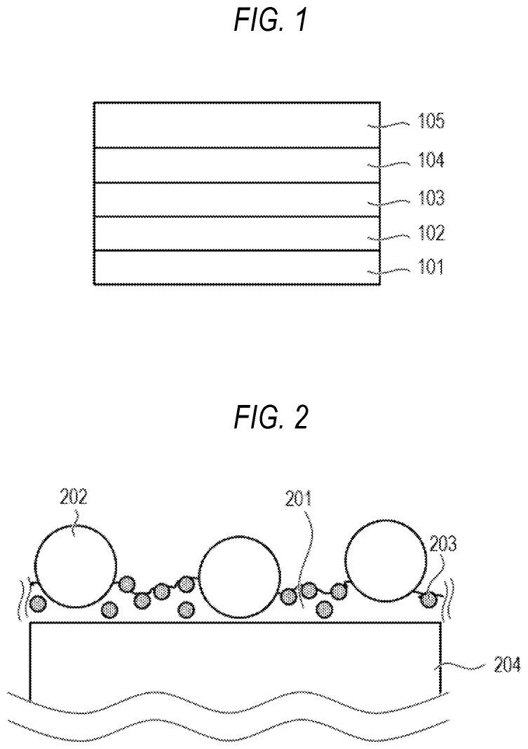

FIG. 1 illustrates a view illustrating one example of a layer structure of the electrophotographic photosensitive member. In FIG. 1, the electrophotographic photosensitive member includes a support 101, an undercoat layer 102, a charge generating layer 103, a charge transporting layer 104, and a surface layer 105 according to the present disclosure.

Due to the above configuration, an electrophotographic photosensitive member can be provided which can withstand use in the image forming apparatus having a long life. The mechanism by which the problem is solved due to the configuration of the present disclosure is not clear, but is presumed to be the following.

A spot image which is generated in the image forming apparatus having a long life is actualized through such a mechanism that contaminants such as a toner, an external additive and a paper dust adhere to the surface of the electrophotographic photosensitive member in an image-forming process, such contamination of the surface of the electrophotographic photosensitive member is repeated, and the contaminants are deposited on the surface of the electrophotographic photosensitive member.

When the contaminants are deposited on the surface of the electrophotographic photosensitive member, an electric charge is accumulated also on the contaminants deposited on the surface of the electrophotographic photosensitive member, in a charging process. The main components of the contaminants are the toner and the external additive, and accordingly, it becomes easier for the contaminants to be charged up than the contaminants on the surface layer of the electrophotographic photosensitive member, which contains an electroconductive particle. Such a contaminated portion does not have the potential of the surface of the electrophotographic photosensitive member, which has been originally intended in the image-forming process, and results in being output as a spot image (a spot-like image defect seen on a halftone image) as an image.

In the electrophotographic photosensitive member of the present disclosure, the surface layer includes a binder resin, a first particle and a second particle; the surface of the surface layer has a convex part derived from the first particle and a convex part derived from the second particle; when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2):

70≤(S1+S2)≤95 (1), and

0.8≤(S1/S2)≤2.0 (2).

When the S1 and the S2 satisfy the expression (1), the most part of the surface layer of the electrophotographic photosensitive member results in being covered with the first particle and the second particle. Thereby, the unevenness which derives from the first particle and the second particle is formed on the surface of the surface layer of the electrophotographic photosensitive member. The uneven shape is in point contact with the contaminants, and accordingly, it becomes easier for the contaminants to be detached from the surface of the electrophotographic photosensitive member than from a general electrophotographic photosensitive member having no uneven shape.

When the S1 and the S2 satisfy the expression (1) and the expression (2), the abundance ratio of the first particle which is the electroconductive particle on the surface of the electrophotographic photosensitive member is sufficiently ensured, and the injection charging property of the electrophotographic photosensitive member can be exhibited.

On the other hand, when the S1 and the S2 do not satisfy 70≤(S1+S2), the area occupied by the resin based on the total area in a top plan view of the surface layer of the electrophotographic photosensitive member becomes relatively large, accordingly the area S1 occupied by the first particle of the injection site decreases, and the injection characteristics are lowered. In addition, the area S2 occupied by the second particle forming the minute uneven shape decreases, then the detachment of the contaminants cannot be promoted, which causes the deposition of the contaminants, and the spot image tends to be easily generated.

When the S1 and the S2 do not satisfy (S1+S2)≤95, the area occupied by the resin on the surface of the electrophotographic photosensitive member becomes small, then, the function of binding the particle to the surface layer of the electrophotographic photosensitive member is weakened, and the particle tends to be easily detached from the surface layer of the electrophotographic photosensitive member due to rubbing with the contact member at the time of image formation. Thereby, when the first particle is detached from the surface layer of the electrophotographic photosensitive member, the injection characteristics tend to be easily lowered due to disappearance of the injection site, and when the second particle is detached, the detaching characteristics of the contaminants tend to be easily lowered due to disappearance of the minute uneven shape.

When the S1 and the S2 do not satisfy 0.8≤(S1/S2), the area S1 occupied by the first particle which is the injection site decreases, and the injection charging characteristics are lowered. In addition, when the S1 and the S2 do not satisfy (S1/S2)≤2.0, the area S2 occupied by the second particle which forms the minute uneven shape decreases, and the detachment of the contaminants from the surface of the electrophotographic photosensitive member cannot be promoted, which causes the deposition of the contaminants, and the spot image tends to be easily generated.

In the electrophotographic photosensitive member of the present disclosure, when an exposure height of the first particle exposed on the surface of the electrophotographic photosensitive member is represented by L1 [nm] and an exposure height of the second particle exposed on the surface of the electrophotographic photosensitive member is represented by L2 [nm], the L1 and the L2 satisfy the following expression (3) and the following expression (4):

50≤L1≤300 (3), and

2.0≤L1/L2≤10.0 (4).

When the L1 and the L2 satisfy the expression (3), it becomes difficult for the first particle to be detached from the surface layer of the electrophotographic photosensitive member, even when the electrophotographic photosensitive member is used for a long period of time, while the injection charging characteristics of the electrophotographic photosensitive member are ensured.

When the L1 and the L2 satisfy the expression (3) and the expression (4), the first particle which is the electroconductive particle results in forming the convex part higher than the second particle which is the insulating particle, and the second particle which is the insulating particle results in forming the convex part lower than the first particle which is the electroconductive particle, on the surface of the electrophotographic photosensitive member. Thereby, it becomes easy for the contaminants to adhere to the surface of the insulating particle which becomes a relatively concave part, and the first particle which is the electroconductive particle is maintained in a state of being exposed on the surface of the electrophotographic photosensitive member. Thereby, even when the electrophotographic photosensitive member has been used for a long period of time, the injection charging characteristics are maintained. In addition, there exists a minute uneven shape due to the insulating particle on the surface formed by the insulating particle that becomes the relatively concave part of the surface layer of the electrophotographic photosensitive member. Furthermore, the second particle has smaller relative permittivity than the first particle. Because of this, the contaminant comes not only in point contact with the surface of the electrophotographic photosensitive members, but also tends to be easily detached from the surface of the electrophotographic photosensitive member, because the electrostatic adhesion is low.

When the L1 does not satisfy the relationship 50≤L1, the exposed height L1 is not sufficiently formed as the electroconductive site, and accordingly, the injection charging characteristics tend to be easily lowered due to the deposition of the contaminants. In addition, when the L1 does not satisfy the relationship L1≤300, the exposed height L1 of the first particle is formed to be high, accordingly, the first particle tends to be easily detached from the surface of the electrophotographic photosensitive member by endurance, and the injection charging characteristics of the electrophotographic photosensitive members are lowered.

When the L1 and the L2 do not satisfy 2.0≤L1/L2, the first particle cannot form enough exposure height L1, and accordingly, the injection charging characteristics tend to be easily lowered due to the deposition of contaminant. When the L1 and the L2 do not satisfy L1/L2≤10.0, the first particle becomes easily detached when the exposure height L1 of the first particle is relatively large, and as a result, the injection charging characteristics are lowered. When the exposure height L2 of the second particle is relatively small, a fine uneven shape cannot be formed, and accordingly, the contaminants are not easily detached, and as a result, the contaminants are deposited on the surface of the electrophotographic photosensitive member, and the spot image is easily generated.

In addition, in the electrophotographic photosensitive member according to the present disclosure, when the number-based average primary particle size of the first particle is represented by D1 [nm] and the number-based average primary particle size of the second particle is represented by D2 [nm], it is preferable that the D1 and the D2 satisfy the following expression (5), the following expression (6) and the following expression (7):

100≤D1≤350 (5),

30≤D2≤150 (6), and

2.0≤D1/D2≤10.0 (7).

Thereby, the electrophotographic photosensitive member can be designed to have a surface profile of the surface layer to which the contaminant resists adhering. Furthermore, it is more preferable to set the expression (5) to 120≤D1≤250, and is further preferable to set to 150≤D1≤220. It is more preferable to set the expression (6) to 30≤D2≤120, and is further preferable to set to 30≤D2≤100. It is more preferable to set the expression (7) to 4.0≤D1/D2≤10.0, and is further preferable to set to 5.5≤D1/D2≤9.0. In the present disclosure, the primary particle size of the particles is utilized in order to design the surface profile of the surface layer of the electrophotographic photosensitive member. When the D1 and the D2 satisfy the expression (5), expression (6) and expression (7), it is enabled to form a protrusion of the first particle which is the electroconductive particle, the protrusion being higher than the second particle which is the insulating particle, on the surface of the surface layer of the electrophotographic photosensitive member.

In addition, in the electrophotographic photosensitive member according to the present disclosure, when the film thickness of the surface layer is represented by T1 [nm] and the number-based average primary particle size of the first particle is represented by D1 [nm], it is preferable for the T1 and the D1 to satisfy the following expression (8):

1.0≤T1/D1≤1.8 (8).

Thereby, the surface profile of the surface layer of the electrophotographic photosensitive member can be designed by utilizing the primary particle diameter of the particle. It is more preferable to set the expression (8) to 1.2≤T1/D1≤1.5. Thereby, the convex part which is formed by the first particle is higher than the film thickness of the layer, but is controlled so as not to be formed by the aggregate of the first particles; and thereby, even when the electrophotographic photosensitive member is used for a long period of time, the injection characteristics are maintained, and the detachment of the first particle can be suppressed because of the friction with the contact member.

In addition, in the electrophotographic photosensitive member of the present disclosure, it is preferable that the powder resistivity R1 of the first particle is 1.0×10⁸ Ω·cm or lower, and that the powder resistivity R2 of the second particle is 1.0×10¹⁰ Ω·cm or higher. The first particle which forms the protrusion higher than the second particle is the electroconductive particle, and the second particle which forms the protrusion lower than the first particle is the insulating particle. Thereby, it becomes easy for the contaminant to adhere to the surface of the insulating particle which becomes a relatively concave part, and it becomes easy for the first particle which is the electroconductive particle to be maintained in a state of being exposed on the surface. In addition, there exists a minute uneven shape due to the insulating particle, in the relatively concave part of the surface layer of the electrophotographic photosensitive member. Furthermore, the second particle has smaller relative permittivity than the first particle. Because of this, the contaminant comes not only in point contact with the surface of the electrophotographic photosensitive member, but also tends to be easily detached, because the electrostatic adhesion is low. As a result, even when the electrophotographic photosensitive member is used for a long period of time, the convex part serving as the injection point can be maintained in a state of being exposed, and the injection characteristics tend to be easily maintained.

In addition, in the electrophotographic photosensitive member of the present disclosure, it is more preferable that the powder resistivity R2 of the second particle is 1.0×10¹³ Ω·cm or higher. Thereby, a material which affects the injection characteristics can be limited only to the first particle. In addition, even when the contaminant adheres to the minute uneven shape portion which is formed by the second particle in the relatively concave part of the surface layer of the electrophotographic photosensitive member, the second particle does not affect the injection characteristics, and accordingly, the injection characteristics of the surface layer of the electrophotographic photosensitive member resist being changed. Because of this, even when the electrophotographic photosensitive member is used for a long period of time, the change in injection characteristics can be diminished.

Note that the above mechanism is based on presumption, and that the presumption does not affect the technical scope of the present disclosure.

### <Binder Resin>

Examples of the binder resin according to the present disclosure include a polyester resin, an acrylic resin, a phenoxy resin, a polycarbonate resin, a polystyrene resin, a phenol resin, a melamine resin, and an epoxy resin. Among the resins, the polycarbonate resin, the polyester resin and the acrylic resin are preferable.

In addition, the surface layer may be formed as a cured film by polymerization of a composition containing a monomer having a polymerizable functional group. Examples of the reaction at that time include a thermal polymerization reaction, a photopolymerization reaction, and a radiation polymerization reaction. Examples of the polymerizable functional group of the monomer having the polymerizable functional group include an acryloyl group and a methacryloyl group. As the monomer having the polymerizable functional group, a material having a charge transporting capability may be used.

A chemical compound having a polymerizable functional group may have a charge transporting structure as well as a chain polymerizable functional group. A triarylamine structure is preferable as the charge transporting structure in terms of charge transport. As the chain polymerizable functional group, an acryloyl group and a methacryloyl group are preferable. The number of the functional groups to be owned may be one or more. Among the chemical compounds, it is particularly preferable to form a cured film which contains a chemical compound having a plurality of functional groups and a chemical compound having one functional group, because the strain generated by the polymerization of the plurality of functional groups tends to be easily eliminated.

Examples of the above chemical compound having one functional group are shown in the following formula (2-1) to the following formula (2-6).

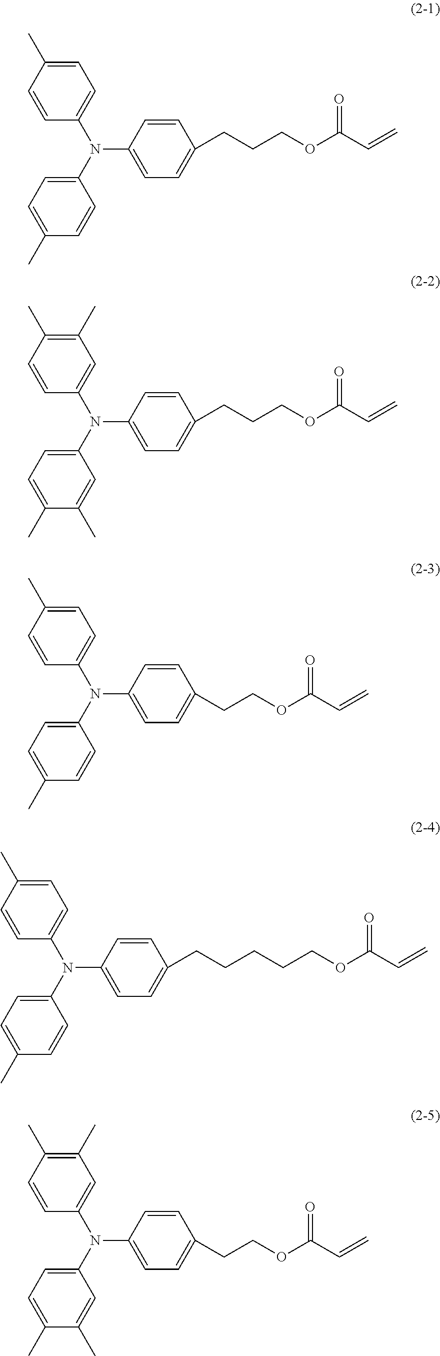

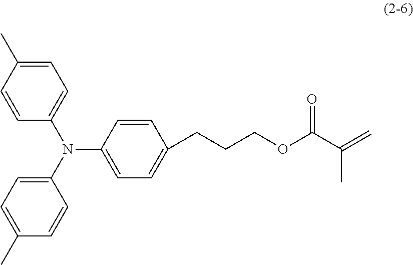 [SMILES: C=C(C)C(=O)OCCCc1ccc(N(c2ccc(C)cc2)c2ccc(C)cc2)cc1]

Examples of the above chemical compound having a plurality of functional groups are shown in the following formula (3-1) to the following formula (3-5).

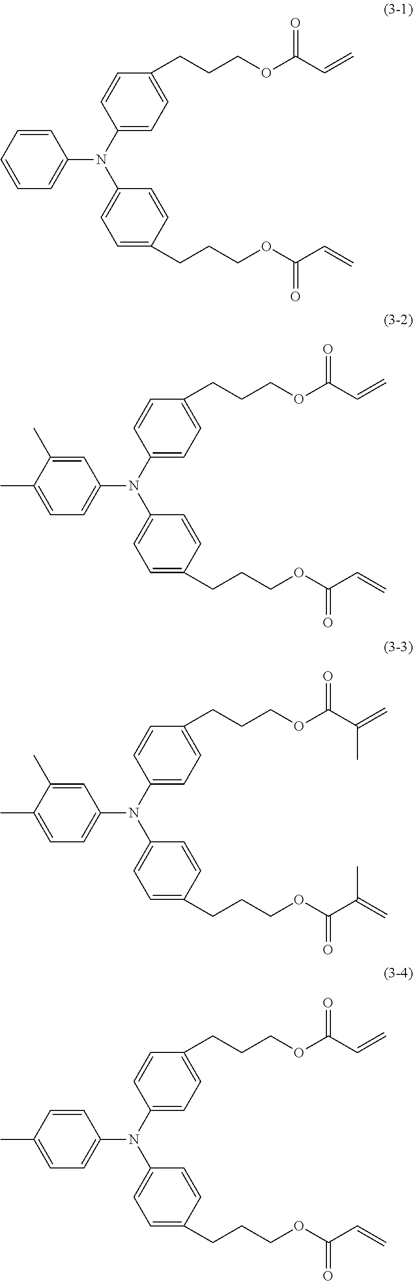

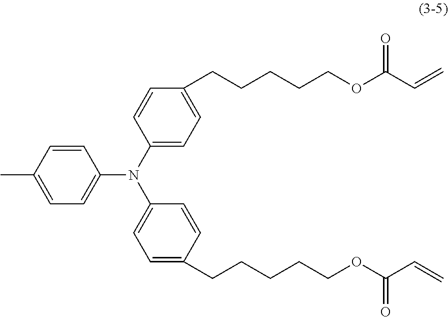 [SMILES: C=CC(=O)OCCCCCc1ccc(N(c2ccc(C)cc2)c2ccc(CCCCCOC(=O)C=C)cc2)cc1]

The surface layer may contain additive agents such as an antioxidizing agent, an ultraviolet absorbing agent, a plasticizing agent, a leveling agent, a slipperiness imparting agent and an abrasion resistance improver. Specific examples thereof include a hindered phenol compound, a hindered amine compound, a sulfur compound, a phosphorus compound, a benzophenone compound, a siloxane modified resin and a silicone oil.

The surface layer can be formed by operations of: preparing a coating liquid for the surface layer, which contains each of the materials that will be described later and a solvent; forming a coating film of the coating liquid on the charge transporting layer or a single-layer type photosensitive layer; and drying and/or curing the coating film. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

### <First Particle>

In the electrophotographic photosensitive member of the present disclosure, the first particle includes any one or more selected from the group consisting of a metal oxide particle, a metal particle and carbon black.

Examples of the metal oxide particles include magnesium oxide, aluminum oxide, titanium oxide, iron oxide, copper oxide, zinc oxide, silver oxide, tantalum oxide, bismuth oxide, cobalt oxide, indium oxide, tin oxide and indium tin oxide. Examples of the metal particles include magnesium, aluminum, titanium, iron, copper, zinc, silver, tin, platinum and gold. These particles may be synthetic compounds or commercialized products. In addition, in order to enhance the dispersion stability of the particles, the hydrophobic treatment may be performed which will be described later.

As methods for producing carbon black, there are a furnace method, a channel method, an acetylene method, a thermal method, and the like, but carbon black produced by the acetylene method is preferable from the viewpoint of having high electroconductivity and containing little impurity.

In addition, the first particle is a material responsible for the injection characteristics of the surface layer of the electrophotographic photosensitive member, and accordingly preferably has a volume resistivity of medium resistance or lower. In addition to this, from the viewpoint of cost and environmental load, metal oxide particles of tin oxide, indium tin oxide, titanium oxide and zinc oxide are preferable. In the electrophotographic photosensitive member of the present disclosure, the first particle preferably includes any one or more selected from the group consisting of a tin oxide particle, an ITO particle, a titanium oxide particle, and a zinc oxide particle. When the first particle satisfies any of the tin oxide particle, the ITO particle, the titanium oxide particle and the zinc oxide particle, the function of the electrophotographic photosensitive member is not inhibited, and the charge injection characteristics to the surface layer of the electrophotographic photosensitive member can be ensured even when the amount added is relatively small. In particular, the titanium oxide particle and the zinc oxide particle are preferable. These particles have a higher volume resistivity than the tin oxide particle and the ITO particle and have a medium resistance, and accordingly, even when discharge products are deposited on a drum surface due to endurance under a high-temperature and high-humidity environment, satisfactory image formation can be maintained as compared with the tin oxide particle and the ITO particle, and electrostatic adhesion is also suppressed; and accordingly, the contaminant having adhered to the convex part is easily removed, and a change in the injection charging property can be kept small.

In the electrophotographic photosensitive member of the present disclosure, the first particle includes a titanium oxide particle doped with niobium; and in an EDS analysis of the titanium oxide particle doped with niobium, which uses a scanning transmission electron microscopy (STEM), it is preferable that the concentration ratio calculated by niobium atom concentration/titanium atom concentration in the inside of 5% of the primary particle diameter of the titanium oxide particle doped with niobium from the surface of the titanium oxide particle doped with niobium is 2.0 times or more with respect to the concentration ratio calculated by niobium atom concentration/titanium atom concentration in the central portion of the titanium oxide particle doped with niobium. Thereby, the resistance of the surface of the titanium oxide particle can be diminished while the powder resistivity is maintained at a medium resistance. Thereby, it becomes easy to maintain a latent image even when a large amount of the first particles is added to the surface layer of the electrophotographic photosensitive member, and a high injection property is ensured.

In the present disclosure, the first particle is preferably a particle that includes particularly an anatase-type titanium oxide particle serving as a core material, and titanium oxide which covers the surface of the core material and contains niobium. As for the form of niobium contained, it is preferable that niobium is contained not as an oxide but in a so-called doped form in which niobium is incorporated into a crystal lattice of titanium oxide. Due to the titanium oxide being doped with niobium, the injection charging property is enhanced.

When the first particle includes the titanium oxide particle containing niobium, it is preferable for a content of niobium in the first particle to be 0.5% by mass or more and 15.0% by mass or less, and is more preferable to be 1.0% by mass or more and 10.0% by mass or less. When the content of niobium in the first particles is 0.5% by mass or more, the electroconductivity of titanium oxide can be increased, and the injection charging property can be enhanced; and when the content of niobium in the first particle is 15.0% by mass or less, the crystal structure of titanium oxide can be maintained, and accordingly, the volume resistivity of the surface layer does not become too large.

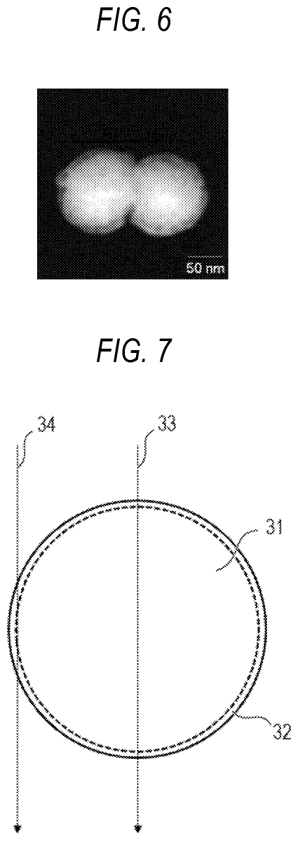

FIG. 6 illustrates a STEM image of one example of a metal oxide in which titanium oxide serving as a core material is coated with titanium oxide containing niobium, similarly to a titanium oxide particle (electroconductive particle 1) used in Examples of the present disclosure. In addition, FIG. 7 illustrates a view schematically illustrating the STEM image of FIG. 6. The detail will be described later, but the titanium oxide particle containing niobium, which is used in the present Examples, is produced by operations of: coating a titanium oxide particle serving as a core material with titanium oxide containing niobium; and then firing the resultant. Because of this, it is considered that the coated titanium oxide containing niobium is crystal-grown as niobium-doped titanium oxide by so-called epitaxial growth, along the crystal of the titanium oxide of the core material.

The titanium oxide containing niobium prepared in this way has a lower density in the vicinity of the surface than in the particle center portion as shown in FIG. 6, and it is understood that the titanium oxide has a core/shell-like form. In addition, in the EDS analysis by STEM, the X-ray penetrates the entire particle, and accordingly as illustrated in FIG. 7, the EDS analysis in the inside of 5% of the primary particle diameter from the surface of the particle as illustrated in the direction of 34 has a larger influence in the vicinity of the surface than the EDS analysis in the particle center portion as illustrated in the direction of 33.

Specifically, in the EDS analysis by STEM as described above, the fact that the atomic ratio of niobium/titanium in the inside of 5% of the primary particle diameter from the surface of the particle is 2.0 times or more with respect to the atomic ratio of niobium/titanium at the center of the particle is considered to be a state in which the niobium element is unevenly distributed in the vicinity of the surface. In FIG. 7, sign 32 indicates a region of the metal oxide particle in the inside of 5% of the primary particle diameter from the surface of the particle, and sign 31 indicates a region of the metal oxide particle inside the region of sign 32. In addition, sign 33 indicates an X-ray for analyzing the central portion of the metal oxide particle, and sign 34 indicates an X-ray for analyzing the inside of 5% of the particle diameter from the surface of the metal oxide particle.

In the EDS analysis by STEM, the ratio of niobium/titanium is measured by EDS through observation by a transmission electron microscope. Alternatively, the ratio of niobium/titanium can be directly measured from the electrophotographic photosensitive member which has been sliced by means of a microtome, Ar milling, FIB or the like.

In addition, it is preferable that the titanium oxide particle containing niobium, which is contained in the surface layer, has oxygen deficiency. When the titanium oxide particle containing niobium has oxygen deficiency, the injection charging property is improved. The detailed mechanism is not well understood, but it is presumed that when the titanium oxide particle containing niobium has oxygen deficiency, the particle tends to easily receive electric charge, and accordingly the injection charging property is enhanced. It is preferable that the oxygen deficiency ratio of the titanium oxide particle containing niobium is 0.1% or higher and 2.0% or lower. When the oxygen deficiency ratio is lower than 0.1%, the improvement of the injection charging property cannot be expected, and when the oxygen deficiency ratio exceeds 2.0%, the color of the particle results in becoming black and the transparency of the surface layer is lowered, which causes reduction in sensitivity of the electrophotographic photosensitive member. In addition, when β represents the oxygen deficiency ratio in the region within 5% of the primary particle diameter from the surface of the titanium oxide particle containing niobium, and γ represents the oxygen deficiency ratio in the other region of the titanium oxide particle containing niobium, it is preferable that β and γ satisfy the following expression (α):

β>10×γ (α).

Thereby, the oxygen deficient portion which tends to easily receive the electric charge is unevenly distributed on the surface of the metal oxide particle, and thus injection charging can be effectively performed.

Here, when A represents the actual oxygen content of the metal oxide particle, and B represents the theoretical oxygen content of the metal oxide particle without oxygen deficiency, the oxygen deficiency ratio of the metal oxide particle can be represented by (B−A)/B×100(%). The oxygen deficiency ratio of the metal oxide particle, and the ratio of the oxygen deficiency ratio of the region within 5% of the primary particle diameter from the surface of the metal oxide particle to the oxygen deficiency ratio of the other region can be measured by energy dispersive X-ray spectroscopy (EDS). In addition, as described above, in the EDS analysis, the X-ray penetrates the entire particle, and accordingly, when the above described relational expression (α) is satisfied, it means that the oxygen deficient portion is unevenly distributed in the vicinity of the particle surface.

The oxygen deficiency can be introduced by an operation of firing the metal oxide particle in a reducing atmosphere such as ammonia or hydrogen, or firing the metal oxide particle together with an organic substance in a nitrogen atmosphere at 600 °C or higher which is a decomposition temperature of the organic substance.

The detailed mechanism is not clear, but it is considered that the reason why the injection charging property is enhanced by doping with niobium or introduction of oxygen deficiency as described above is that the metal oxide particle tends to easily transfer the electric charge from the electroconductive particle such as carbon black or graphite which is generally used in the charging member, and the movement of the electric charge from the charging member to the electrophotographic photosensitive member becomes smooth.

### <Second Particle>

In the electrophotographic photosensitive member according to the present disclosure, the second particle includes a silica particle.

The silica particles have a larger mean circularity than other inorganic particles, and accordingly it is expected that the silica particle has an effect of promoting point contact between contaminant and the surface of the electrophotographic photosensitive member, and thereby reducing an adhesive force.

As the silica particle, a known silica fine particle can be used, and the silica particle may be either a dry silica fine particle or a wet silica fine particle. Preferably, the silica fine particle is a fine particle of wet silica, which is obtained by a sol-gel method (hereinafter, also referred to as sol-gel silica).

The sol-gel silica to be used for the particle contained in the surface layer of the electrophotographic photosensitive member of the present disclosure may be hydrophilic or may be sol-gel silica of which the surface is subjected to the hydrophobic treatment.

Examples of the method of the hydrophobic treatment include: a method of removing the solvent from a silica sol suspension, in the sol-gel method, drying the resultant, and then treating the resultant with a hydrophobic treatment agent; and a method of directly adding a hydrophobic treatment agent to the silica sol suspension, and treating the resultant simultaneously with drying. From the viewpoint of controlling the half width of the particle size distribution and controlling the saturated water adsorption amount, a method of directly adding the hydrophobic treatment agent to the silica sol suspension is preferable.

Examples of the hydrophobic treatment agent include:
chlorosilanes such as methyl trichlorosilane, dimethyl dichlorosilane, trimethyl chlorosilane, phenyl trichlorosilane, diphenyl dichlorosilane, t-butyl dimethyl chlorosilane and vinyl trichlorosilane;
alkoxysilanes such as tetramethoxysilane, methyl trimethoxysilane, dimethyl dimethoxysilane, phenyl trimethoxysilane, diphenyl dimethoxysilane, o-methylphenyl trimethoxysilane, p-methylphenyl trimethoxysilane, n-butyl trimethoxysilane, i-butyl trimethoxysilane, hexyl trimethoxysilane, octyl trimethoxysilane, decyl trimethoxysilane, dodecyl trimethoxysilane, tetraethoxysilane, methyl triethoxysilane, dimethyl diethoxysilane, phenyl triethoxysilane, diphenyl diethoxysilane, i-butyl triethoxysilane, decyl triethoxysilane, vinyl triethoxysilane, γ-methacryloxypropyl trimethoxysilane, γ-glycidoxypropyl trimethoxysilane, γ-glycidoxypropylmethyl dimethoxysilane, γ-mercaptopropyl trimethoxysilane, γ-chloropropyl trimethoxysilane, γ-aminopropyl trimethoxysilane, γ-aminopropyl triethoxysilane, γ-(2-aminoethyl) aminopropyl trimethoxysilane, and γ-(2-aminoethyl) aminopropyl methyl dimethoxysilane;
silazanes such as hexamethyl disilazane, hexaethyl disilazane, hexapropyl disilazane, hexabutyl disilazane, hexapentyl disilazane, hexahexyl disilazane, hexacyclohexyl disilazane, hexaphenyl disilazane, divinyltetramethyl disilazane, and dimethyltetravinyl disilazane;
silicone oils such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal-reactive silicone oil;
siloxanes such as hexamethyl cyclotrisiloxane, octamethyl cyclotetrasiloxane, decamethyl cyclopentasiloxane, hexamethyl disiloxane, and octamethyl trisiloxane;
as fatty acids and metal salts of the fatty acids, long-chain fatty acids such as undecylic acid, lauric acid, tridecylic acid, dodecyclic acid, myristic acid, palmitic acid, pentadecylic acid, stearic acid, heptadecylic acid, arachidic acid, montanic acid, oleic acid, linoleic acid, and arachidonic acid, as fatty acids; and salts thereof with a metal such as zinc, iron, magnesium, aluminum, calcium, sodium, and lithium.

Among the agents, alkoxysilanes, silazanes and silicone oil are preferably used, because of being easily subjected to the hydrophobic treatment. These hydrophobic treatment agents may be used alone or in combination of two or more types thereof.

### <Additive Agent>

The surface layer in the present disclosure may contain additive agents such as a catalyst for a polymerization reaction, an antioxidizing agent, an ultraviolet absorbing agent, a plasticizing agent, a leveling agent, a slipperiness imparting agent and an abrasion resistance improver. Specific examples thereof include a quaternary ammonium salt, a hindered phenol compound, a hindered amine compound, a sulfur compound, a phosphorus compound, a benzophenone compound, a siloxane modified resin and a silicone oil.

### <Solvent>

A solvent which stably disperses or dissolves the binder resin, the inorganic particles and the additive agent may be appropriately selected. Specific examples thereof include the followings:
alcohols such as methanol, ethanol, isopropanol, butanol and octanol; ketones such as acetone and cyclohexanone;
esters such as ethyl acetate, butyl acetate, ethyl lactate, γ-butyrolactone, propylene glycol monomethyl ether acetate, and propylene glycol monoethyl ether acetate;
ethers such as ethylene glycol monomethyl ether and diethylene glycol monobutyl ether;
aromatic hydrocarbons such as benzene, toluene and xylene; and
amides such as dimethylformamide, dimethylacetamide, and N-methylpyrrolidone.

In addition, in order to adjust a drying rate of a film of a curable composition and to adjust a viscosity of the curable composition to a viscosity suitable for coating, a plurality of solvents may be used in combination.

### <Surface Layer>

The surface layer can be formed by operations of: preparing a coating liquid for a surface layer containing each of the above described materials and a solvent; forming a coating film of the coating liquid; and drying and/or curing the coating film.

FIG. 2 illustrates a view illustrating an example of a configuration of the surface layer of the electrophotographic photosensitive member. In FIG. 2, the surface layer of the electrophotographic photosensitive member includes a binder resin 201, a first particle 202, a second particle 203, and a lower layer 204 on which the surface layer is coated.

### <Support>

In the present disclosure, it is preferable that the electrophotographic photosensitive member has a support. In the present disclosure, it is preferable that the support is an electroconductive support having electroconductivity. In addition, examples of the shape of the support include a cylindrical shape, a belt shape, and a sheet shape. Among the shapes, a cylindrical support is preferable. In addition, the surface of the support may be subjected to electrochemical treatment such as anodization, blasting, cutting, or the like.

As a material of the support, a metal, a resin, glass or the like is preferable. Examples of the metal include aluminum, iron, nickel, copper, gold, stainless steel, and alloys thereof. Among the metals, an aluminum support using aluminum is preferable.

In addition, the electroconductivity may be imparted to the resin or the glass, by treatment such as mixing of or coating with an electroconductive material.

### <Electroconductive Layer>

In the present disclosure, an electroconductive layer may be provided on the support. Due to the electroconductive layer being provided, scratches and unevenness on the surface of the support can be concealed, and reflection of light on the surface of the support can be controlled. It is preferable that the electroconductive layer contains the electroconductive particle and the resin.

Examples of a material of the electroconductive particle include a metal oxide, a metal, and carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Among these substances, it is preferable to use a metal oxide as the electroconductive particle, and is more preferable to use, in particular, titanium oxide, tin oxide and zinc oxide.

When the metal oxide is used as the electroconductive particle, the surface of the metal oxide may be treated with a silane coupling agent or the like, or the metal oxide may be doped with an element such as phosphorus and aluminum, or an oxide thereof.

The electroconductive particle may have a layered structure in which an uncoated particle such as titanium oxide, barium sulfate and zinc oxide is coated with a metal oxide having a different composition from that of the uncoated particle. Examples of the coating include a metal oxide such as tin oxide.

In addition, when a metal oxide is used as the electroconductive particle, it is preferable for an average primary particle size thereof to be 1 nm or larger and 500 nm or smaller, and is more preferable to be 3 nm or larger and 400 nm or smaller.

Examples of the resin include a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a concealing agent such as a silicone oil, a resin particle and titanium oxide.

It is preferable for an average film thickness of the electroconductive layer to be 1 μm or larger and 50 μm or smaller, and is particularly preferable to be 3 μm or larger and 40 μm or smaller.

The electroconductive layer can be formed by operations of: preparing a coating liquid for the electroconductive layer, which contains each of the above described materials and a solvent; forming a coating film of the coating liquid; and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. Examples of a dispersion method for dispersing the electroconductive particles in the coating liquid for the electroconductive layer include methods which use a paint shaker, a sand mill, a ball mill, and a liquid collision type high-speed dispersion machine, respectively.

### <Undercoat Layer>

In the present disclosure, an undercoat layer may be provided on the support or the electroconductive layer.

It is preferable for an average film thickness of the undercoat layer to be 0.1 μm or larger and 50 μm or smaller, is more preferable to be 0.2 μm or larger and 40 μm or smaller, and is particularly preferable to be 0.3 μm or larger and 30 μm or smaller.

Examples of the resin of the undercoat layer include a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamide acid resin, a polyurethane resin, a polyimide resin, a polyamide-imide resin, a polyvinyl phenol resin, a melamine resin, a phenol resin, an epoxy resin, and an alkyd resin.

In addition, the resin may be a resin having a structure in which a resin having a polymerizable functional group and a monomer having a polymerizable functional group are crosslinked.

In addition, the undercoat layer may contain an inorganic compound or an organic compound in addition to the resin.

Examples of the inorganic compound include a metal, an oxide and a salt.

Examples of the metal include gold, silver and aluminum. Examples of the oxide include zinc oxide, white lead, aluminum oxide, indium oxide, silicon oxide, zirconium oxide, tin oxide, titanium oxide, magnesium oxide, antimony oxide, bismuth oxide, indium oxide and zirconium oxide. Examples of the salt include barium sulfate and strontium titanate.

These inorganic compounds may exist in the film in a form of a particle.

It is preferable for the number-average particle size of the particles to be 1 nm or larger and 500 nm or smaller, and is more preferable to be 3 nm or larger and 400 nm or smaller.

These inorganic compounds may have a layered structure having a core material particle and a covering layer which covers the particle.

The surfaces of these inorganic compounds may be treated with a silicone oil, a silane compound, a silane coupling agent, in addition, an organic silicon compound, an organic titanium compound, or the like. In addition, the surfaces of these inorganic compounds may be doped with an element such as tin, phosphorus, aluminum or niobium.

Examples of the organic compound include an electron transporting compound and an electroconductive polymer.

Examples of the electroconductive polymer include polythiophene, polyaniline, polyacetylene, polyphenylene, and polyethylene dioxythiophene.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound and a boron-containing compound.

The electron transporting substance has a polymerizable functional group, and may be crosslinked with a resin having a functional group capable of reacting with the polymerizable functional group. Examples of the polymerizable functional group include a hydroxy group, a thiol group, an amino group, a carboxyl group, a vinyl group, an acryloyl group, a methacryloyl group and an epoxy group.

These organic compounds may exist in the film in a form of a particle, and the surface thereof may be treated.

The undercoat layer may contain various additive agents such as a leveling agent such as silicone oil, a plasticizing agent, and a thickener.

The undercoat layer is obtained by operations of: preparing a coating liquid for the undercoat layer containing the above materials; applying the coating liquid onto a support or an electroconductive layer; and then drying or curing the coating film.

Examples of the solvent to be used in the preparation of the coating liquid include an alcohol-based solvent, a ketone-based solvent, an ether-based solvent, an ester-based solvent, or an aromatic hydrocarbon-based solvent.

Examples of a dispersion method for dispersing the particles in the coating liquid include methods which use a paint shaker, a sand mill, a ball mill, and a liquid collision type high-speed dispersion machine, respectively.

### <Photosensitive Layer>

The photosensitive layer of the electrophotographic photosensitive member is mainly classified into (1) a layered type photosensitive layer and (2) a single-layer type photosensitive layer. (1) A layered type photosensitive layer is a photosensitive layer which includes a charge generating layer containing a charge generating substance, and a charge transporting layer containing a charge transporting substance. (2) The single-layer type photosensitive layer is a photosensitive layer containing both a charge generating substance and a charge transporting substance.

### (1) Layered Type Photosensitive Layer

The layered type photosensitive layer includes a charge generating layer and a charge transporting layer.

### (1-1) Charge Generating Layer

It is preferable that the charge generating layer contains a charge generating substance and a resin.

Examples of the charge generating substance include an azo pigment, a perylene pigment, a polycyclic quinone pigment, an indigo pigment and a phthalocyanine pigment. Among the pigments, the azo pigment and the phthalocyanine pigment are preferable. Among the phthalocyanine pigments, an oxytitanium phthalocyanine pigment, a chlorogallium phthalocyanine pigment and a hydroxygallium phthalocyanine pigment are preferable.

It is preferable for a content of the charge generating substance in the charge generating layer to be 40% by mass or more and 85% by mass or less, and is more preferable to be 60% by mass or more and 80% by mass or less, based on the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among these resins, the polyvinyl butyral resin is more preferable.

In addition, the charge generating layer may further contain an additive agent such as an antioxidizing agent or an ultraviolet absorbing agent. Specific examples thereof include a hindered phenol compound, a hindered amine compound, a sulfur compound, a phosphorus compound and a benzophenone compound.

The charge generating layer can be formed by operations of: preparing a coating liquid for the charge generating layer, where the coating liquid contains each of the above materials and a solvent; forming a coating film of the coating liquid on the undercoat layer; and drying the resultant. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

It is preferable for a film thickness of the charge generating layer to be 0.1 μm or larger and 1.5 μm or smaller, and is more preferable to be 0.15 μm or larger and 1.0 μm or smaller.

### (1-2) Charge Transporting Layer

It is preferable that the charge transporting layer contains a charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and resins having a group derived from these substances, respectively. Among these substances, the triarylamine compound and the benzidine compound are preferable.

It is preferable for a content of the charge transporting substance in the charge transporting layer to be 25% by mass or more and 70% by mass or less, and is more preferable to be 30% by mass or more and 55% by mass or less, based on the total mass of the charge transporting layer.

Examples of the resin include a polyester resin, a polycarbonate resin, an acrylic resin and a polystyrene resin. Among these resins, the polycarbonate resin and the polyester resin are preferable. As the polyester resins, a polyarylate resin is particularly preferable.

It is preferable for the content ratio (mass ratio) of the charge transporting substance to the resin to be 4:10 to 20:10, and is more preferable to be 5:10 to 12:10.

In addition, the charge transporting layer may contain additive agents such as an antioxidizing agent, an ultraviolet absorbing agent, a plasticizing agent, a leveling agent, a slipperiness imparting agent and an abrasion resistance improver. The specific additive agents include a hindered phenol compound, a hindered amine compound, a sulfur compound, a phosphorus compound, a benzophenone compound, a siloxane modified resin, a silicone oil, a fluororesin particle, a polystyrene resin particle, a polyethylene resin particle, a silica particle, an alumina particle and a boron nitride particle.

The charge transporting layer can be formed by operations of: preparing a coating liquid for the charge transporting layer, which contains each of the above materials and a solvent, forming a coating film of the coating liquid on the charge generating layer, and drying the coating film. Examples of the solvent to be used for the coating liquid include an alcohol-based solvent, a ketone-based solvent, an ether-based solvent, an ester-based solvent, and an aromatic hydrocarbon-based solvent. Among these solvents, the ether-based solvent or the aromatic hydrocarbon-based solvent is preferable.

It is preferable for a film thickness of the charge transporting layer to be 3 μm or larger and 50 μm or smaller, is more preferable to be 5 μm or larger and 40 μm or smaller, and is particularly preferable to be 10 μm or larger and 30 μm or smaller.

### (2) Single-Layer Type Photosensitive Layer

The single-layer type photosensitive layer can be formed by operations of: preparing a coating liquid for the photosensitive layer, which contains the charge generation substance, the charge transporting substance, a resin and a solvent; forming a coating film of the coating liquid on the undercoat layer; and drying the resultant. The charge generation substance, the charge transporting substance and the resin are the same as the examples of the materials in the above “(1) Layered type photosensitive layer”.

It is preferable for a film thickness of the single-layer type photosensitive layer to be 10 μm or larger and 45 μm or smaller, and is more preferable to be 25 μm or larger and 35 μm or smaller.

### <Process Cartridge and Electrophotographic Apparatus>

A process cartridge of the present disclosure integrally supports the electrophotographic photosensitive member of the present disclosure and at least one unit selected from the group consisting of a charging unit, a developing unit and a cleaning unit, and is freely attachable to and detachable from a main body of an electrophotographic apparatus. The electrophotographic apparatus of the present disclosure includes the electrophotographic photosensitive member of the present disclosure, the charging unit, an exposing unit, the developing unit and a transfer unit.

### (Configuration of Electrophotographic Apparatus)

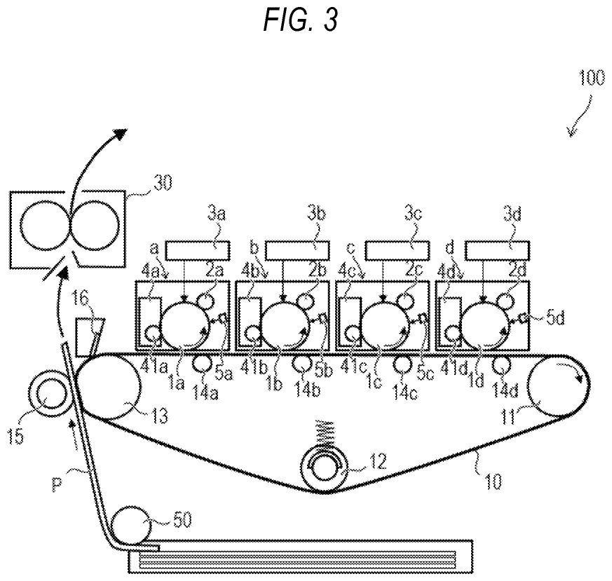

FIG. 3 illustrates one example of a schematic configuration of the electrophotographic apparatus including the process cartridge equipped with the electrophotographic photosensitive member of the present disclosure.

The electrophotographic apparatus of the present Example is a so-called tandem-type electrophotographic apparatus in which a plurality of image forming units a to d are provided. The first image forming unit a forms an image with toner of yellow (Y), the second image forming unit b forms an image with toner of magenta (M), the third image forming unit c forms an image with toner of cyan (C), and the fourth image forming unit d forms an image with toner of black (Bk). These four image forming units are arranged in a line at fixed intervals, and the structures of the respective image forming units are substantially and largely common except for the colors of the toners contained therein. Accordingly, the electrophotographic apparatus of the present Example will be described below with the use of the first image forming unit a.

The first image forming unit a includes a photosensitive drum 1a which is a drum-shaped electrophotographic photosensitive member, a charging roller 2a which is a charging member, and a developing unit 4a (including a developing roller 41a).

The photosensitive drum 1a is an image carrying body which carries a toner image, and is rotationally driven at a predetermined peripheral speed (process speed) in the illustrated arrow direction. The developing unit 4a contains yellow toner and develops the yellow toner on the photosensitive drum 1a.

When a control unit (unillustrated) such as a controller receives an image signal, an image forming operation is started, and the photosensitive drum 1a is rotationally driven. The photosensitive drum 1a is uniformly submitted to charging treatment to a predetermined voltage (charging voltage) with a predetermined polarity (negative polarity in the present Example) by the charging roller 2a in a rotation process, and is exposed to light by the exposure unit 3a corresponding to the image signal. Thereby, an electrostatic latent image corresponding to an image of a yellow color component of a target color image is formed on the photosensitive drum 1a. Next, the electrostatic latent image is developed by the developing unit 4a at the developing position, and is visualized as a yellow toner image on the photosensitive drum 1a. Here, the normal charging polarity of the toner accommodated in the developing unit 4a is negative, and the electrostatic latent image is reversely developed by the toner charged to the same polarity as the charging polarity of the photosensitive drum 1a by the charging roller 2a. However, the present disclosure is not limited to the reverse development, but also can be applied to an electrophotographic apparatus that submits an electrostatic latent image to positive development with toner charged to an opposite polarity to the charging polarity of the photosensitive drum 1a.

In addition, a large number of convex parts derived from particles can be provided on the surface layer of the charging roller 2a. The convex part provided on the surface layer of the charging roller 2a has a role of a spacer between the charging roller 2a and the photosensitive drum 1a in the charging portion. The role is a role to suppress the charging roller 2a from being contaminated with a transfer residual toner by the contact of the portion other than the convex part with the transfer residual toner, when the transfer residual toner has entered the charging portion, which is the toner remaining on the photosensitive drum 1a without being transferred in the primary transfer portion that will be described below.

The pre-exposure unit 5a serving as a charge eliminating unit eliminates the charges, by exposing the surface of the photosensitive drum 1a before the surface of the photosensitive drum 1a is charged by the charging roller 2a. The pre-exposure unit 5a has a role of equalizing surface potentials formed on the photosensitive drum 1 and a role of controlling the amount of discharge caused by discharge which is generated in the charging portion, by eliminating the charges on the surface of the photosensitive drum 1a.

An intermediate transfer belt 10 which can move in an endless way has electroconductivity, forms a primary transfer portion by coming in contact with the photosensitive drum 1a, and rotates at substantially the same peripheral speed as the photosensitive drum 1a. In addition, the intermediate transfer belt 10 is stretched by an opposing roller 13 serving as an opposing member, the driving roller 11 and a stretching roller 12 serving as stretching members, and a metallic roller 14a, and is stretched by the stretching roller 12 with a tensile force of the total pressure 60 N. The intermediate transfer belt 10 can be moved by the driving roller 11 being rotationally driven in the illustrated arrow direction.

The yellow toner image formed on the photosensitive drum 1a is primarily transferred from the photosensitive drum 1a to the intermediate transfer belt 10 in a process of passing through the primary transfer portion.

At the time of the primary transfer, an electric current is supplied from a secondary transfer roller 15 serving as a secondary transfer member which comes in contact with an outer peripheral surface of the intermediate transfer belt 10, to the electroconductive intermediate transfer belt 10. The electric current supplied from the secondary transfer roller 15 flows in the circumferential direction of the intermediate transfer belt 10, and thereby, the toner image is primarily transferred from the photosensitive drum 1a to the intermediate transfer belt 10. At this time, a voltage of a predetermined polarity (positive polarity in the present Example) opposite to the normal charging polarity of the toner is applied from a transfer power supply (unillustrated) to the secondary transfer roller 15.

Subsequently, a magenta toner image of a second color, a cyan toner image of a third color and a black toner image of a fourth color are similarly formed, and sequentially are transferred onto the intermediate transfer belt 10 in a superimposed way. Thereby, four color toner images corresponding to respective target color images are formed on the intermediate transfer belt 10. After that, the four color toner images carried on the intermediate transfer belt 10 are collectively secondary-transferred onto a surface of a transfer material P such as paper or an OHP sheet fed by a sheet feeding unit 50, in a process in which the four color toner images pass through a secondary transfer portion formed by contact between a secondary transfer roller 15 and the intermediate transfer belt 10. The transfer material P onto which the four color toner images are transferred by the secondary transfer is then heated and pressed by a fixing unit 30, and thereby, the four color toners are melted and mixed, and fixed to the transfer material P. The toner which has remained on the intermediate transfer belt 10 after the secondary transfer is cleaned and removed by a belt cleaning unit 16 which is provided so as to face the opposing roller 13 via the intermediate transfer belt 10.

The electrophotographic photosensitive member of the present disclosure can be used in laser beam printers, LED printers, copying machines and the like.

### EXAMPLES

The present disclosure will be described below in more detail with reference to Examples and Comparative Examples. The present disclosure is not limited to the following Examples at all, as long as the present disclosure does not exceed the gist thereof.

Note that “part(s)” in the description of the following Examples is based on mass unless otherwise specified. In addition, the film thickness of the layers other than the surface layer of the electrophotographic photosensitive members of Examples and Comparative Examples was measured with an eddy-current film thickness meter (product name: Fischerscope, manufacturer: Fischer Instruments K. K.) or calculated from the mass per unit area in terms of specific weight.

### Production Example (1) of Electrophotographic Photosensitive Member 1

An aluminum cylinder (standard: JIS-A3003, aluminum alloy) was used as a support (electroconductive support), which had a diameter of 20 mm and a length of 257.5 mm.

The support, an electroconductive layer, an undercoat layer, a charge generating layer, a charge transporting layer and a surface layer were prepared according to the following methods.

### (Preparation of Coating Liquid for Electroconductive Layer)

As a base substance, anatase-type titanium oxide was used of which the average primary particle size was 200 nm, and a titanium niobium sulfate solution was prepared which contained 33.7 parts of titanium in terms of TiO₂ and 2.9 parts of niobium in terms of Nb₂O₅. In pure water, 100 parts of the base substance were dispersed to prepare 1000 parts of a suspension liquid, and the resultant was heated to 60 °C. The titanium niobium sulfate solution and a 10 mol/L solution of sodium hydroxide were added dropwise to the suspension liquid over 3 hours so that a pH of the suspension liquid became 2 to 3. After the whole quantity was added dropwise, the pH was adjusted to the vicinity of neutrality, and a polyacrylamide-based flocculant was added to settle a solid content. The supernatant was removed, the rest was filtered, and the residue was cleaned and then dried at 110 °C to obtain an intermediate which contained 0.1 mass % of an organic substance which was derived from the flocculant, in terms of C. This intermediate was fired in nitrogen gas at 750 °C for 1 hour, then was fired at 450 °C in air, and a titanium oxide particle 1 was produced. The average primary particle size of the obtained particles was 220 nm in the particle size measurement method using the scanning electron microscope, which will be described later.

Subsequently, 50 parts of a phenol resin (monomer/oligomer of phenol resin) (product name: Pryophen J-325, manufacturer: DIC Corporation, resin solid content: 60%, and density after curing: 1.3 g/cm³) as a binder material were dissolved in 35 parts of 1-methoxy-2-propanol as a solvent, and the solution was obtained.

To this solution, 60 parts of the titanium oxide particle 1 were added; and the resultant liquid was used as a dispersion medium, and was charged into a vertical sand mill which used 120 parts of glass beads having a number average primary particle size of 1.0 mm. After that, the mixture was subjected to dispersion treatment under conditions of a dispersion liquid temperature of 23±3 °C and a number of revolutions of 1500 rpm (circumferential velocity: 5.5 m/s) for 4 hours, and a dispersion liquid was obtained. The glass beads were removed from the dispersion liquid with a mesh. Into the dispersion liquid from which the glass beads were removed, 0.01 parts of silicone oil (product name: SH28 PAINT ADDITIVE, manufacturer: Dow Corning Toray Co., Ltd.) as a leveling agent, and 8 parts of a silicone resin particle (product name: KMP-590, manufacturer: Shin-Etsu Chemical Co., Ltd., average primary particle size: 2 μm, and density: 1.3 g/cm³) as a surface roughness imparting material were added; and the resultant was stirred. After that, the resultant was pressure filtered with the use of a PTFE filter paper (product name: PF060, manufacturer: Advantec Toyo Kaisha, Ltd.), and thereby a coating liquid for the electroconductive layer was prepared.

### (Preparation of Coating Liquid for Undercoat Layer)

One hundred parts of rutile-type titanium dioxide particles (average primary particle size: 50 nm, manufacturer: Tayca Corporation) were stirred and mixed with 500 parts of toluene, and 3.5 parts of vinyltrimethoxysilane (product name: KBM-1003, manufacturer: Shin-Etsu Chemical Co., Ltd.) were added thereto; and the resultant was subjected to dispersion treatment for 8 hours in a vertical sand mill which used glass beads having a diameter of 1.0 mm. After the glass beads were removed, the toluene was distilled off under reduced pressure, the resultant was dried at 120 °C for 3 hours, and thereby a rutile-type titanium dioxide particle was obtained which was already surface-treated with an organosilicon compound. When the volume of the obtained titanium dioxide particles was represented by a and the average primary particle size of the titanium dioxide particles was represented by b [μm], the ratio a/b was 15.6. The value of a was determined from a microscopic image of a cross section of the electrophotographic photosensitive member, with the use of a field emission scanning electron microscope (FE-SEM, product name: S-4800, manufacturer: Hitachi High-Technologies Corporation) after the electrophotographic photosensitive member was produced.

A dispersion liquid was prepared by an operation of adding 18.0 parts of the rutile-type titanium dioxide particles which were submitted to surface treatment with the organosilicon compound, 4.5 parts of N-methoxymethylated nylon (product name: Torejin (registered trade mark) EF-30T, manufacturer: Nagase ChemteX Corporation), and 1.5 parts of copolymerized nylon resin (product name: Amilan (registered trade mark) CM8000, manufacturer: Toray Industries, Inc.) to a mixed solvent of 90 parts of methanol and 60 parts of 1-butanol.

This dispersion liquid was subjected to dispersion treatment for 5 hours in a vertical sand mill which used glass beads having a diameter of 1.0 mm, the glass beads were removed, and thereby a coating liquid for an undercoat layer was prepared.

### (Synthesis of Phthalocyanine Pigment)

### Synthesis Example

Under an atmosphere of nitrogen flow, 100 g of gallium trichloride and 291 g of orthophthalonitrile were added to 1000 mL of α-chloronaphthalene, the mixture was reacted at a temperature of 200 °C for 24 hours, and then the product was filtered. The obtained wet cake was added to N,N-dimethylformamide; and the mixture was heated and stirred at a temperature of 150 °C for 30 minutes, and then was filtered. The obtained residue was cleaned with methanol, and then was dried; and a chlorogallium phthalocyanine pigment was obtained at a yield of 83 mas %.

In 500 ml of concentrated sulfuric acid, 20 g of the chlorogallium phthalocyanine pigment were dissolved which was obtained by the above method; the resultant was stirred for 2 hours, and then was added dropwise into an ice-cooled mixed solution of 1700 mL of distilled water and 660 mL of concentrated ammonia water; and chlorogallium phthalocyanine was redeposited. The redeposit was sufficiently washed with distilled water and dried, and a hydroxygallium phthalocyanine pigment was obtained.

### (Preparation of Coating Liquid for Charge Generating Layer)

A mixture of 0.5 parts of the hydroxygallium phthalocyanine pigment obtained in Synthesis Example, 7.5 parts of N,N-dimethyl formamide (product code: D0722, manufacturer: Tokyo Chemical Industry Co., Ltd.), and 29 parts of glass beads having a diameter of 0.9 mm was subjected to milling treatment under a temperature of 25 °C for 24 hours with the use of a sand mill (product name: BSG-20, manufacturer: Aimex Co., Ltd.). At this time, the milling treatment was performed under the condition that the disk rotated at 1500 rotations per minute. The thus treated liquid was filtered through a filter (product number: N-NO. 125T, pore size: 133 μm, manufacturer: NBC Meshtec Inc.), and glass beads were removed. To this liquid, 30 parts of N,N-dimethylformamide were added, then the resultant was filtered, and the filtration residue on the filter was sufficiently cleaned with n-butyl acetate. Then, the cleaned filtration residue was vacuum-dried, and 0.45 parts of a hydroxygallium phthalocyanine pigment were obtained. The obtained pigment contained N,N-dimethylformamide.

Subsequently, 20 parts of the hydroxygallium phthalocyanine pigment obtained by the milling treatment, 10 parts of polyvinyl butyral (product name: S-LEC (registered trade name) BX-1, manufacturer: Sekisui Chemical Co., Ltd.), 190 parts of cyclohexanone and 482 parts of glass beads having a diameter of 0.9 mm were subjected to dispersion treatment under cooling water at a temperature of 18 °C for 4 hours, with the use of a sand mill (product name: K-800, manufacturer: Igarashi Machine Manufacture Co., Ltd. (Aimex Co., Ltd. at present), disk diameter of 70 mm, and the number of disks being 5 disks). At this time, the dispersion treatment was performed under the condition that the disk rotated at 1800 rotations per minute. From this dispersion liquid, the glass beads were removed, and 444 parts of cyclohexanone and 634 parts of ethyl acetate were added thereto; and thereby, a coating liquid for the charge generating layer was prepared.

### (Preparation of Coating Liquid for Charge Transporting Layer)

### (Production Example of Charge Transporting Layer)

Next, the following materials were prepared, and a mixed solvent was prepared.

| | |
|---|---|
| Ortho-xylene | 25 parts by mass |
| Methyl benzoate | 25 parts by mass |
| Dimethoxymethane | 25 parts by mass |

Furthermore, the following materials were dissolved in the mixed solvent, and a coating liquid for the charge transporting layer was prepared.
Charge transporting substance (hole transporting substance) represented by the following structural formula (C-1) 5 parts by mass
Charge transporting substance (hole transporting substance) represented by the following structural formula (C-2) 5 parts by mass
Polycarbonate (product name: Iupilon (registered trade name) Z400, manufacturer: Mitsubishi Engineering-Plastics Corporation) 10 parts by mass

The charge generating layer 1 was dip-coated with this coating liquid 1 for a charge transporting layer, a coating film was formed thereon; and the coating film was dried at a drying temperature of 40 °C for 5 minutes, and thereby, a charge transporting layer 1 was formed which had a film thickness of 15 μm.

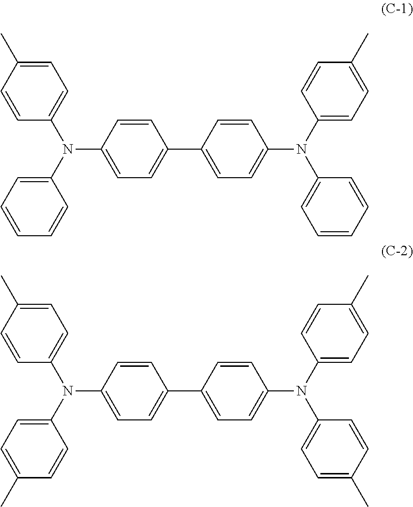

### Production Example (2) of Electrophotographic Photosensitive Member 1

### (Support)

An aluminum cylinder (standard: JIS-A3003, aluminum alloy) was used as a support (electroconductive support), which had a diameter of 20 mm and a length of 257.5 mm.

### (Electroconductive Layer)

The above described support was dip-coated with the coating liquid for the electroconductive layer, and a coating film was formed thereon; the coating film was heated at 150 °C for 30 minutes, and was cured; and thereby, the electroconductive layer was formed which had a film thickness of 22 μm.

### (Undercoat Layer)

The above described electroconductive layer was dip-coated with the coating liquid for the undercoat layer, and a coating film was formed thereon; and the coating film was heated at 100 °C for 10 minutes, and was cured; and thereby, an undercoat layer was formed which had a film thickness of 1.8 μm.

### (Charge Generating Layer)

The above described undercoat layer was dip-coated with the coating liquid for the charge generating layer, and a coating film was formed thereon; and the coating film was heated and dried at a temperature of 100 °C for 10 minutes, and thereby, a charge generating layer was formed which had a film thickness of 0.20 μm.

### (Charge Transporting Layer)

The above described charge generating layer was dip-coated with the coating liquid for the charge transporting layer, and a coating film was formed thereon; and the coating film was heated and dried at a temperature of 120 °C for 30 minutes, and thereby, a charge transporting layer was formed which had a film thickness of 21 μm.

### (Surface Layer)

As the binder resin, the first particle, the second particle and the additive agents, commercially available products or products synthesized by oneself may be used. A method for producing the niobium-doped titanium oxide will be described later.

### Production of Anatase-Type Titanium Oxide

The anatase-type titanium oxide particle can be produced by a known sulfuric acid method. The titanium oxide is produced by operations of: heating a solution containing titanium sulfate or titanyl sulfate as a titanium compound, hydrolyzing the chemical compound, and producing a slurry of the titanium dioxide; and dehydrating and firing the slurry of the titanium dioxide. Thereby, anatase-type titanium oxide is obtained which has almost 100% of anatase-type degree.

In the above method, the concentration of the titanyl sulfate solution was controlled, and thereby, anatase-type titanium oxide particles 1 to 11 were produced as shown in Table 1.

TABLE 1

| | Average primary |
|---|---|
| Titanium oxide particle | particle size [nm] |
| Anatase-type titanium oxide particle 1 | 167 |
| Anatase-type titanium oxide particle 2 | 58 |
| Anatase-type titanium oxide particle 3 | 83 |
| Anatase-type titanium oxide particle 4 | 100 |
| Anatase-type titanium oxide particle 5 | 125 |
| Anatase-type titanium oxide particle 6 | 183 |
| Anatase-type titanium oxide particle 7 | 208 |
| Anatase-type titanium oxide particle 8 | 250 |
| Anatase-type titanium oxide particle 9 | 292 |
| Anatase-type titanium oxide particle 10 | 333 |
| Anatase-type titanium oxide particle 11 | 375 |

### Production of Electroconductive Particle 1

Niobium (V) hydroxide was dissolved in concentrated sulfuric acid, and mixed with an aqueous solution of titanium sulfate; and an acidic mixed liquid of a niobium salt and a titanium salt (hereinafter referred to as “titanium-niobium mixed liquid”) was prepared.

The anatase-type titanium oxide particle 1 was dispersed in water as a core material particle to form a suspension liquid, and the suspension liquid was heated to 70 °C while being stirred.

A titanium-niobium mixed liquid which contained 337 g/kg of Ti and 10.3 g/kg of Nb based on the weight of the anatase-type titanium oxide particle 1 and an aqueous sodium hydroxide solution were simultaneously added, while the pH was maintained at 2.5.

After the dropwise addition was finished, the suspension liquid was filtered, washed, and dried at 110 °C for 8 hours. The dried product was fired in a nitrogen atmosphere at 725 °C for 1 hour, and a niobium-doped titanium oxide was obtained in which niobium atoms were unevenly distributed in the vicinity of the surface. One hundred parts of this niobium-doped titanium oxide were mixed with 6.0 parts of a chemical compound represented by the following formula (S-1) (product name: trimethoxypropylsilane, manufactured by Tokyo Chemical Industry Co., Ltd.) and 200 parts of toluene, and the mixture was stirred for 4 hours with a stirring apparatus, then, filtered, washed, and further heated at 120 °C for 3 hours; and niobium-doped titanium oxide 1 having an average particle size of 70 nm was obtained, and was determined to be electroconductive particle 1.

The obtained niobium-doped titanium oxide was observed with a transmission electron microscope (product name: JEM2800, manufacturer: JEOL Ltd.), and the ratio of niobium atoms to titanium atoms at the particle center portion and at the inside of 5% of the particle diameter from the surface of the particle was measured with EDS (product name: NORAN SYSTEM7, manufacturer: Thermo Fisher Scientific Inc.). The observation was performed for 10 particles in each of the sliced samples, and the arithmetic average value was adopted. The obtained ratios of niobium atoms to titanium atoms at the particle center portion and at the inside of 5% of the particle diameter from the surface of the particle were determined as α1 and α2, respectively. α2/α1 was defined as the uneven distribution ratio of niobium, and was calculated; and as a result, the value was 7.7. For information, as for the measurement conditions for the EDS, the acceleration voltage was 200 kV, and the beam size was 1.0 nm.

In the production of the niobium-doped titanium oxide, the average particle size, the volume resistivity and the uneven distribution ratio of niobium of the niobium-doped titanium oxide can be changed by operations of changing the type of the core material particle to be used and the weight ratio of the niobium atoms and the titanium atoms in the titanium-niobium mixed liquid with respect to the core material. The details of the niobium-doped titanium oxide experimentally produced at this time were described in Table 2. For information, it can be confirmed by EDS that the covering layer is the niobium-doped titanium oxide.

In addition, the film thickness of the covering layer was estimated from the thickness of a portion at which the density in the vicinity of the surface was lower than the density in the particle center portion, with reference to the obtained STEM image, and was described in Table 2.

The oxygen deficiency ratio of the electroconductive particle 1 was measured with the use of a thermogravimetric measurement apparatus (product name: Q5000IR, manufacturer: TAInstruments). A temperature rising rate at the time of the measurement was 10 °C/min, and the measurement was performed under an oxygen stream. The mass at a temperature at which the mass started to increase in a range of 300 °C to 900 °C was determined as the minimum mass, and the oxygen deficiency ratio was determined from the minimum mass and the maximum mass during the subsequent heating, and was described in Table 2.

In addition, the ratio of the oxygen deficiency ratio of the core material of the electroconductive particle 1 to the oxygen deficiency ratio of the covering layer can be measured by energy dispersive X-ray spectroscopy (EDS).

In addition, the oxygen deficiency ratio β of the region within 5% of the primary particle diameter from the surface of the niobium-doped titanium oxide particle and the oxygen deficiency ratio γ of the other region were measured by energy dispersive X-ray spectroscopy (EDS) which uses STEM, and the value of β/γ was described in Table 2.

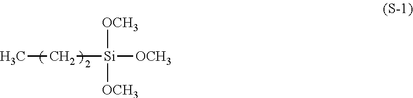

### <Production of Electroconductive Particles 2 to 17>

Electroconductive particles 2 to 17 were produced in the same way as in the production of the electroconductive particle 1, except that the type of the core material particle to be used and the weight of the niobium atoms and the titanium atoms in the titanium-niobium mixed liquid in the production of the electroconductive particle 1 were changed as in Table 2. The average particle size, volume resistivity and uneven distribution ratio of niobium of the obtained electroconductive particles 2 to 17 are shown in Table 2.

### <Quantification of Niobium Atom Contained in Electroconductive Particle>

The niobium atoms contained in the electroconductive particle are quantified in the following way.

The electroconductive particles are pelletized by the following press molding, and a sample is produced. The produced sample is used for measurement with the use of an X-ray fluorescence analyzer (XRF), and the content of the niobium atoms in the entire electroconductive particle is quantified by the FP method.

Specifically, the content of niobium atoms is quantified as niobium pentoxide, and is converted into the content of niobium atoms contained.

### (i) Example of Apparatus to be Used

X-ray fluorescence spectrometer 3080 (Rigaku Holdings Corporation)

### (ii) Sample Preparation

The samples are prepared with the use of a sample press molding machine MAEKAWA Testing Machine (manufacturer: MATSUI MFG CO., LTD). Into an aluminum ring (model number: 3481E1), 0.5 g of the electroconductive particles are placed, are pressed for 1 minute at a load of 5.0 tons, and are pelletized.

(iii) Measurement Conditions
Measurement diameter: 10 φ
Measurement potential, voltage: 50 kV, 50 to 70 mA
2θ angle: 25.12°
Crystal plate: LiF
Measurement time: 60 seconds

TABLE 2

| | | | | | | Titanium- | | |
|---|---|---|---|---|---|---|---|---|
| | | | | | | niobium | | |
| | | | | | | mixture liquid | | |
| | | Core material particle | | Firing | | Weight ratio of | Covering layer | |
| | Particle | | Particle | Temperature | | niobium atom/ | | Layer |
| | diameter (nm) | Type | diameter (nm) | (° C.) | Atmosphere | titanium atom | Type | thickness (nm) |
| Electroconductive | 200 | Anatase-type | 167 | 725 | N₂ | 10.3/337 | Niobium-doped | 17 |
| particle 1 | | titanium oxide 1 | | | | | titanium oxide | |
| Electroconductive | 70 | Anatase-type | 58 | 725 | N₂ | 10.3/337 | Niobium-doped | 6 |
| particle 2 | | titanium oxide 2 | | | | | titanium oxide | |
| Electroconductive | 100 | Anatase-type | 83 | 725 | N₂ | 10.3/337 | Niobium-doped | 8 |
| particle 3 | | titanium oxide 3 | | | | | titanium oxide | |
| Electroconductive | 120 | Anatase-type | 100 | 725 | N₂ | 10.3/337 | Niobium-doped | 10 |
| particle 4 | | titanium oxide 4 | | | | | titanium oxide | |
| Electroconductive | 150 | Anatase-type | 125 | 725 | N₂ | 10.3/337 | Niobium-doped | 13 |
| particle 5 | | titanium oxide 5 | | | | | titanium oxide | |
| Electroconductive | 220 | Anatase-type | 183 | 725 | N₂ | 10.3/337 | Niobium-doped | 18 |
| particle 6 | | titanium oxide 6 | | | | | titanium oxide | |
| Electroconductive | 250 | Anatase-type | 208 | 725 | N₂ | 10.3/337 | Niobium-doped | 21 |
| particle 7 | | titanium oxide 7 | | | | | titanium oxide | |
| Electroconductive | 300 | Anatase-type | 250 | 725 | N₂ | 10.3/337 | Niobium-doped | 25 |
| particle 8 | | titanium oxide 8 | | | | | titanium oxide | |
| Electroconductive | 350 | Anatase-type | 292 | 725 | N₂ | 10.3/337 | Niobium-doped | 29 |
| particle 9 | | titanium oxide 9 | | | | | titanium oxide | |
| Electroconductive | 400 | Anatase-type | 333 | 725 | N₂ | 10.3/337 | Niobium-doped | 33 |
| particle 10 | | titanium oxide | | | | | titanium oxide | |
| | | 10 | | | | | | |
| Electroconductive | 450 | Anatase-type | 375 | 725 | N₂ | 10.3/337 | Niobium-doped | 38 |
| particle 11 | | titanium oxide | | | | | titanium oxide | |
| | | 11 | | | | | | |
| Electroconductive | 200 | Anatase-type | 167 | 725 | N₂ | 4.2/337 | Niobium-doped | 17 |
| particle 12 | | titanium oxide 1 | | | | | titanium oxide | |
| Electroconductive | 200 | Anatase-type | 167 | 725 | N₂ | 2.1/337 | Niobium-doped | 17 |
| particle 13 | | titanium oxide 1 | | | | | titanium oxide | |
| Electroconductive | 200 | Anatase-type | 167 | 725 | N₂ | 21.0/337 | Niobium-doped | 17 |
| particle 14 | | titanium oxide 1 | | | | | titanium oxide | |
| Electroconductive | 200 | Anatase-type | 167 | 650 | N₂ | 10.3/337 | Niobium-doped | 17 |
| particle 15 | | titanium oxide 1 | | | | | titanium oxide | |
| Electroconductive | 200 | Anatase-type | 167 | 725 | N₂/O₂ = | 10.3/337 | Niobium-doped | 17 |
| particle 16 | | titanium oxide 1 | | | 99/1 | | titanium oxide | |
| Electroconductive | 200 | Anatase-type | 167 | 725 | N₂/O₂ = | 10.3/337 | Niobium-doped | 17 |
| particle 17 | | titanium oxide 1 | | | 90/10 | | titanium oxide | |

| | Oxygen | | | | | |
|---|---|---|---|---|---|---|
| | deficiency ratio | | | | | |
| | (β) within 5% of | | | | | |
| | primary particle | | | | | |
| | from surface/ | | | | | |
| | oxygen | | | | Uneven | |
| | deficiency ratio | Powder | Oxygen | | distribution | |
| | (γ) in particle | resistance | deficiency | Specific | ratio of | Nb |
| | center portion | (Ω · cm) | ratio | gravity | niobium | Content |
| Electroconductive | 33 | 1.5 × 10⁵ | 1.8% | 4.0 | 7.7 | 1.1% |
| particle 1 | | | | | | |
| Electroconductive | 33 | 3.4 × 10⁵ | 1.8% | 4.0 | 7.7 | 1.1% |
| particle 2 | | | | | | |
| Electroconductive | 33 | 2.5 × 10⁵ | 1.8% | 4.0 | 7.7 | 1.1% |
| particle 3 | | | | | | |
| Electroconductive | 33 | 2.1 × 10⁵ | 1.8% | 4.0 | 7.7 | 1.1% |
| particle 4 | | | | | | |
| Electroconductive | 33 | 1.8 × 10⁵ | 1.8% | 4.0 | 7.7 | 1.1% |
| particle 5 | | | | | | |
| Electroconductive | 33 | 1.4 × 10⁵ | 1.8% | 4.0 | 7.7 | 1.1% |
| particle 6 | | | | | | |
| Electroconductive | 33 | 1.3 × 10⁵ | 1.8% | 4.0 | 7.7 | 1.1% |
| particle 7 | | | | | | |
| Electroconductive | 33 | 1.2 × 10⁵ | 1.8% | 4.0 | 7.7 | 1.1% |
| particle 8 | | | | | | |
| Electroconductive | 33 | 1.1 × 10⁵ | 1.8% | 4.0 | 7.7 | 1.1% |
| particle 9 | | | | | | |
| Electroconductive | 33 | 1.0 × 10⁵ | 1.8% | 4.0 | 7.7 | 1.1% |
| particle 10 | | | | | | |
| Electroconductive | 33 | 1.0 × 10⁵ | 1.8% | 4.0 | 7.7 | 1.1% |
| particle 11 | | | | | | |
| Electroconductive | 33 | 7.2 × 10⁵ | 1.8% | 4.0 | 3.8 | 0.4% |
| particle 12 | | | | | | |
| Electroconductive | 33 | 1.5 × 10⁶ | 1.8% | 4.0 | 1.8 | 0.2% |
| particle 13 | | | | | | |
| Electroconductive | 33 | 8.2 × 10⁴ | 1.8% | 4.1 | 16.0 | 2.2% |
| particle 14 | | | | | | |
| Electroconductive | 15 | 3.5 × 10⁵ | 1.1% | 4.0 | 7.7 | 1.1% |
| particle 15 | | | | | | |
| Electroconductive | 10 | 7.5 × 10⁵ | 0.5% | 4.0 | 7.7 | 1.1% |
| particle 16 | | | | | | |
| Electroconductive | 5 | 1.7 × 10⁶ | 0.1% | 4.0 | 7.7 | 1.1% |
| particle 17 | | | | | | |

The ratio S1 of an area occupied by the first particle and the ratio S2 of an area occupied by the second particle to the total area in a top plan view of the surface layer can be adjusted mainly by the mixing ratio of the resin and the particle. For example, the ratio of (S1+S2) can be increased by an operation of increasing the mixing ratio of the particle with respect to the amount of the resin. In addition, (S1/S2) can be adjusted by adjustment of the mixing ratio of the first particle and the second particle.

An exposure height L1 of the first particle which is exposed on the surface of the electrophotographic photosensitive member and an exposure height L2 of the second particle which is exposed thereon can be adjusted by a drying temperature after coating, a type of solvent, and a solid content of the coating liquid. For example, when a solvent type having a high volatilization rate is used, convection at the time of drying becomes fast, and the exposure height of the particle tends to increase. For the same reason, the exposure height of the particle increases even when the drying temperature after coating is increased. When the solid content of the coating liquid is increased, the convection is suppressed, and accordingly, the exposure height of the particle tends to decrease.

A film thickness T1 of the surface layer of the electrophotographic photosensitive member can be adjusted by a solid component of the coating liquid and a coating speed at the time of dip coating. For example, when the solid component of the coating liquid is increased, the film thickness T1 becomes thicker. In addition, the film thickness T1 becomes thick by increase of the coating speed at the time of the dip coating.

### Production Example (3) of Electrophotographic Photosensitive Member 1

### <Preparation of Coating Liquid 1 for Surface Layer>

A coating liquid 1 for a surface layer was prepared by operations of: mixing an electroconductive particle 6 in an amount of 8.40 parts as a first particle,
silica particle (“QSG-80”, manufacturer: Shin-Etsu Chemical Co., Ltd.) in an amount of 3.78 parts as a second particle,
a chemical compound shown by the following formula (O-1) in an amount of 3.60 parts as a binder resin,
1-propanol in an amount of 91 parts, and
cyclohexane in an amount of 91 parts; and
stirring the mixture for 6 hours with a stirring/dispersing apparatus.

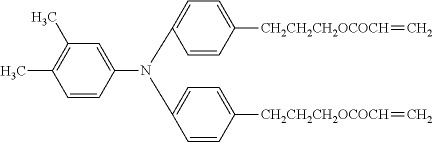

### <Production Examples of Electrophotographic Photosensitive Members 2 to 52>

Electrophotographic photosensitive members 2 to 52 were prepared by operations of: producing the layers up to the charge transporting layer in the same way as in the Production Example of the electrophotographic photosensitive member 1; and changing the materials of the coating liquids 2 to 52 for the surface layers to be used for producing the surface layers, respectively, as shown in Table 3. At this time, the dispersion step of the coating liquid for the surface layer was appropriately adjusted. The electrophotographic photosensitive members 2 to 52 were produced in the same way as in the electrophotographic photosensitive member 1, with the use of the prepared coating liquids for surface layers, respectively. Specifically, the electrophotographic photosensitive members 2 to 52 were produced in the same way as the electrophotographic photosensitive member 1, with the use of coating liquids 2 to 52 for surface layers, respectively. On this occasion, the coating conditions in a coating step of a surface layer of the electrophotographic photosensitive member were appropriately adjusted. The results are shown in Table 4. In Table 4, in the EDS analysis of the niobium-doped titanium oxide particle by a scanning transmission electron microscope (STEM), the concentration ratio calculated by the niobium atom concentration/the titanium atom concentration in the inside of 5% of the primary particle diameter of the niobium-doped titanium oxide particle from the surface of the niobium-doped titanium oxide particle, to the concentration ratio calculated by the niobium atom concentration/the titanium atom concentration in the center portion of the niobium-doped titanium oxide particle was described as “the Nb concentration/the Ti concentration in the inside of 5% of the primary particle diameter from the surface of the first particle to the Nb concentration/the Ti concentration at the center portion of the first particle”.

TABLE 3

| | First particle | | | | | |
|---|---|---|---|---|---|---|
| Coating liquid for surface layer No | Type | R1[Ω · cm] | Amount [parts by mass] | | | |
| Coating liquid for surface layer 1 | Electroconductive particle 1 | 1.51 × 10⁵ | 8.40 | | | |
| Coating liquid for surface layer 2 | Electroconductive particle 6 | 1.40 × 10⁵ | 8.40 | | | |
| Coating liquid for surface layer 3 | Electroconductive particle 3 | 2.46 × 10⁵ | 8.00 | | | |
| Coating liquid for surface layer 4 | Electroconductive particle 3 | 2.46 × 10⁵ | 8.00 | | | |
| Coating liquid for surface layer 5 | Electroconductive particle 9 | 1.10 × 10⁵ | 8.65 | | | |
| Coating liquid for surface layer 6 | Electroconductive particle 11 | 1.00 × 10⁵ | 8.65 | | | |
| Coating liquid for surface layer 7 | Electroconductive particle 3 | 2.46 × 10⁵ | 5.33 | | | |
| Coating liquid for surface layer 8 | Electroconductive particle 3 | 2.46 × 10⁵ | 5.33 | | | |
| Coating liquid for surface layer 9 | Electroconductive particle 9 | 1.10 × 10⁵ | 4.27 | | | |
| Coating liquid for surface layer 10 | Electroconductive particle 11 | 1.00 × 10⁵ | 5.87 | | | |
| Coating liquid for surface layer 11 | Electroconductive particle 3 | 2.46 × 10⁵ | 16.26 | | | |
| Coating liquid for surface layer 12 | Electroconductive particle 3 | 2.46 × 10⁵ | 16.16 | | | |
| Coating liquid for surface layer 13 | Electroconductive particle 9 | 1.10 × 10⁵ | 16.08 | | | |
| Coating liquid for surface layer 14 | Electroconductive particle 11 | 1.00 × 10⁵ | 15.52 | | | |
| Coating liquid for surface layer 15 | Electroconductive particle 3 | 2.46 × 10⁵ | 10.89 | | | |
| Coating liquid for surface layer 16 | Electroconductive particle 3 | 2.46 × 10⁵ | 10.89 | | | |
| Coating liquid for surface layer 17 | Electroconductive particle 9 | 1.10 × 10⁵ | 11.10 | | | |
| Coating liquid for surface layer 18 | Electroconductive particle 11 | 1.00 × 10⁵ | 10.89 | | | |
| Coating liquid for surface layer 19 | Electroconductive particle 7 | 1.28 × 10⁵ | 8.19 | | | |
| Coating liquid for surface layer 20 | Electroconductive particle 3 | 2.46 × 10⁵ | 8.19 | | | |
| Coating liquid for surface layer 21 | Electroconductive particle 3 | 2.46 × 10⁵ | 8.19 | | | |
| Coating liquid for surface layer 22 | Electroconductive particle 9 | 1.10 × 10⁵ | 8.27 | | | |
| Coating liquid for surface layer 23 | Electroconductive particle 11 | 1.00 × 10⁵ | 8.19 | | | |
| Coating liquid for surface layer 24 | Electroconductive particle 7 | 1.28 × 10⁵ | 4.27 | | | |
| Coating liquid for surface layer 25 | Electroconductive particle 7 | 1.28 × 10⁵ | 6.40 | | | |
| Coating liquid for surface layer 26 | Electroconductive particle 7 | 1.28 × 10⁵ | 10.36 | | | |
| Coating liquid for surface layer 27 | Electroconductive particle 7 | 1.28 × 10⁵ | 15.86 | | | |
| Coating liquid for surface layer 28 | Electroconductive particle 3 | 2.46 × 10⁵ | 7.20 | | | |
| Coating liquid for surface layer 29 | Electroconductive particle 7 | 1.28 × 10⁵ | 10.08 | | | |
| Coating liquid for surface layer 30 | Electroconductive particle 9 | 1.10 × 10⁵ | 8.40 | | | |
| Coating liquid for surface layer 31 | Electroconductive particle 3 | 2.46 × 10⁵ | 8.40 | | | |
| Coating liquid for surface layer 32 | Electroconductive particle 3 | 2.46 × 10⁵ | 5.33 | | | |
| Coating liquid for surface layer 33 | Electroconductive particle 3 | 2.46 × 10⁵ | 8.00 | | | |
| Coating liquid for surface layer 34 | Electroconductive particle 9 | 1.10 × 10⁵ | 6.00 | | | |
| Coating liquid for surface layer 35 | Electroconductive particle 9 | 1.10 × 10⁵ | 9.00 | | | |
| Coating liquid for surface layer 36 | Electroconductive particle 10 | 1.00 × 10⁵ | 11.57 | | | |
| Coating liquid for surface layer 37 | Carbon Black | 2.20 × 10⁻¹ | 4.54 | | | |
| Coating liquid for surface layer 38 | Indium Tin Oxide, Blue | 3.50 × 10⁻² | 16.27 | | | |
| Coating liquid for surface layer 39 | ZnO-05 | 1.00 × 10⁸ | 13.86 | | | |
| Coating liquid for surface layer 40 | Electroconductive particle 11 | 1.00 × 10⁵ | 8.40 | | | |
| Coating liquid for surface layer 41 | Electroconductive particle 12 | 7.22 × 10⁵ | 8.40 | | | |
| Coating liquid for surface layer 42 | Electroconductive particle 13 | 1.50 × 10⁶ | 8.40 | | | |
| Coating liquid for surface layer 43 | Electroconductive particle 14 | 8.22 × 10⁴ | 8.40 | | | |
| Coating liquid for surface layer 44 | Electroconductive particle 15 | 3.50 × 10⁵ | 8.40 | | | |
| Coating liquid for surface layer 45 | Electroconductive particle 16 | 7.51 × 10⁵ | 8.40 | | | |
| Coating liquid for surface layer 46 | Electroconductive particle 2 | 3.40 × 10⁵ | 9.16 | | | |
| Coating liquid for surface layer 47 | Electroconductive particle 7 | 1.28 × 10⁵ | 8.19 | | | |
| Coating liquid for surface layer 48 | Electroconductive particle 9 | 1.10 × 10⁵ | 8.19 | | | |
| Coating liquid for surface layer 49 | Electroconductive particle 8 | 1.20 × 10⁵ | 8.19 | | | |
| Coating liquid for surface layer 50 | Electroconductive particle 6 | 1.40 × 10⁵ | 8.40 | | | |
| Coating liquid for surface layer 51 | Electroconductive particle 6 | 1.40 × 10⁵ | 6.00 | | | |
| Coating liquid for surface layer 52 | Electroconductive particle 6 | 1.40 × 10⁵ | 10.80 | | | |
| | | | | Amount of | | |
| | Second particle | | | binder resin | Amount of solvent [parts | |
| | | | Amount [parts | [parts by | by mass] | |
| Coating liquid for surface layer No | Type | R2[Ω · cm] | by mass] | mass] | 1-Propanol | Cyclohexane |
| Coating liquid for surface layer 1 | QSG-80 | 1.00 × 10¹⁵ | 3.78 | 3.60 | 91 | 91 |
| Coating liquid for surface layer 2 | QSG-80 | 1.00 × 10¹⁵ | 3.78 | 3.60 | 105 | 105 |
| Coating liquid for surface layer 3 | QSG-10 | 1.00 × 10¹⁵ | 1.80 | 3.60 | 77 | 77 |
| Coating liquid for surface layer 4 | QSG-30 | 1.00 × 10¹⁵ | 1.80 | 3.60 | 105 | 105 |
| Coating liquid for surface layer 5 | QSG-30 | 1.00 × 10¹⁵ | 2.05 | 3.60 | 128 | 128 |
| Coating liquid for surface layer 6 | QSG-100 | 1.00 × 10¹⁵ | 2.05 | 3.60 | 148 | 148 |
| Coating liquid for surface layer 7 | QSG-10 | 1.00 × 10¹⁵ | 3.00 | 3.60 | 69 | 69 |
| Coating liquid for surface layer 8 | QSG-30 | 1.00 × 10¹⁵ | 3.00 | 3.60 | 93 | 93 |
| Coating liquid for surface layer 9 | QSG-30 | 1.00 × 10¹⁵ | 2.40 | 3.60 | 90 | 90 |
| Coating liquid for surface layer 10 | QSG-100 | 1.00 × 10¹⁵ | 3.30 | 3.60 | 133 | 133 |
| Coating liquid for surface layer 11 | QSG-10 | 1.00 × 10¹⁵ | 3.48 | 3.60 | 135 | 135 |
| Coating liquid for surface layer 12 | QSG-30 | 1.00 × 10¹⁵ | 3.53 | 3.60 | 182 | 182 |
| Coating liquid for surface layer 13 | QSG-30 | 1.00 × 10¹⁵ | 3.56 | 3.60 | 208 | 208 |
| Coating liquid for surface layer 14 | QSG-100 | 1.00 × 10¹⁵ | 3.82 | 3.60 | 238 | 238 |
| Coating liquid for surface layer 15 | QSG-10 | 1.00 × 10¹⁵ | 5.90 | 3.60 | 117 | 117 |
| Coating liquid for surface layer 16 | QSG-30 | 1.00 × 10¹⁵ | 5.90 | 3.60 | 160 | 160 |
| Coating liquid for surface layer 17 | QSG-30 | 1.00 × 10¹⁵ | 5.81 | 3.60 | 184 | 184 |
| Coating liquid for surface layer 18 | QSG-100 | 1.00 × 10¹⁵ | 5.90 | 3.60 | 210 | 210 |
| Coating liquid for surface layer 19 | QSG-80 | 1.00 × 10¹⁵ | 2.79 | 3.60 | 101 | 101 |
| Coating liquid for surface layer 20 | QSG-30 | 1.00 × 10¹⁵ | 2.79 | 3.60 | 84 | 84 |
| Coating liquid for surface layer 21 | QSG-30 | 1.00 × 10¹⁵ | 2.79 | 3.60 | 114 | 114 |
| Coating liquid for surface layer 22 | QSG-30 | 1.00 × 10¹⁵ | 2.76 | 3.60 | 132 | 132 |
| Coating liquid for surface layer 23 | QSG-100 | 1.00 × 10¹⁵ | 2.79 | 3.60 | 151 | 151 |
| Coating liquid for surface layer 24 | QSG-80 | 1.00 × 10¹⁵ | 2.40 | 3.60 | 70 | 70 |
| Coating liquid for surface layer 25 | QSG-80 | 1.00 × 10¹⁵ | 1.44 | 3.60 | 78 | 78 |
| Coating liquid for surface layer 26 | QSG-80 | 1.00 × 10¹⁵ | 6.14 | 3.60 | 142 | 142 |
| Coating liquid for surface layer 27 | QSG-80 | 1.00 × 10¹⁵ | 3.66 | 3.60 | 166 | 166 |
| Coating liquid for surface layer 28 | QSG-30 | 1.00 × 10¹⁵ | 2.16 | 3.60 | 80 | 80 |
| Coating liquid for surface layer 29 | QSG-100 | 1.00 × 10¹⁵ | 3.02 | 3.60 | 114 | 114 |
| Coating liquid for surface layer 30 | QSG-100 | 1.00 × 10¹⁵ | 3.78 | 3.60 | 108 | 108 |
| Coating liquid for surface layer 31 | QSG-30 | 1.00 × 10¹⁵ | 3.78 | 3.60 | 100 | 100 |
| Coating liquid for surface layer 32 | QSG-30 | 1.00 × 10¹⁵ | 3.00 | 3.60 | 74 | 74 |
| Coating liquid for surface layer 33 | QSG-30 | 1.00 × 10¹⁵ | 1.80 | 3.60 | 83 | 83 |
| Coating liquid for surface layer 34 | QSG-170 | 1.00 × 10¹⁵ | 2.70 | 3.60 | 79 | 79 |
| Coating liquid for surface layer 35 | QSG-100 | 1.00 × 10¹⁵ | 4.05 | 3.60 | 116 | 116 |
| Coating liquid for surface layer 36 | QSG-170 | 1.00 × 10¹⁵ | 2.89 | 3.60 | 128 | 128 |
| Coating liquid for surface layer 37 | QSG-100 | 1.00 × 10¹⁵ | 3.02 | 3.60 | 80 | 80 |
| Coating liquid for surface layer 38 | QSG-10 | 1.00 × 10¹⁵ | 3.44 | 3.60 | 153 | 153 |
| Coating liquid for surface layer 39 | QSG-100 | 1.00 × 10¹⁵ | 3.02 | 3.60 | 88 | 88 |
| Coating liquid for surface layer 40 | QSG-80 | 1.00 × 10¹⁵ | 3.78 | 3.60 | 91 | 91 |
| Coating liquid for surface layer 41 | QSG-80 | 1.00 × 10¹⁵ | 3.78 | 3.60 | 91 | 91 |
| Coating liquid for surface layer 42 | QSG-80 | 1.00 × 10¹⁵ | 3.78 | 3.60 | 91 | 91 |
| Coating liquid for surface layer 43 | QSG-80 | 1.00 × 10¹⁵ | 3.78 | 3.60 | 91 | 91 |
| Coating liquid for surface layer 44 | QSG-80 | 1.00 × 10¹⁵ | 3.78 | 3.60 | 91 | 91 |
| Coating liquid for surface layer 45 | QSG-80 | 1.00 × 10¹⁵ | 3.78 | 3.60 | 91 | 91 |
| Coating liquid for surface layer 46 | QSG-10 | 1.00 × 10¹⁵ | 3.44 | 3.60 | 153 | 153 |
| Coating liquid for surface layer 47 | QSG-80 | 1.00 × 10¹⁵ | 2.79 | 3.60 | 148 | 148 |
| Coating liquid for surface layer 48 | QSG-170 | 1.00 × 10¹⁵ | 2.79 | 3.60 | 58 | 58 |
| Coating liquid for surface layer 49 | QSG-170 | 1.00 × 10¹⁵ | 2.79 | 3.60 | 80 | 80 |
| Coating liquid for surface layer 50 | QSG-80 | 1.00 × 10¹⁵ | 3.78 | 3.60 | 104 | 104 |
| Coating liquid for surface layer 51 | QSG-80 | 1.00 × 10¹⁵ | 2.70 | 3.60 | 104 | 104 |
| Coating liquid for surface layer 52 | QSG-80 | 1.00 × 10¹⁵ | 4.86 | 3.60 | 104 | 104 |

Details of the first particles and the second particles are as follows.
QSG-10 (manufacturer: Shin-Etsu Chemical Co., Ltd.)
QSG-30 (manufacturer: Shin-Etsu Chemical Co., Ltd.)
QSG-80 (manufacturer: Shin-Etsu Chemical Co., Ltd.)
QSG-100 (manufacturer: Shin-Etsu Chemical Co., Ltd.)
QSG-170 (manufacturer: Shin-Etsu Chemical Co., Ltd.)
KE-P30 (manufacturer: Nippon Shokubai Co., Ltd.)
KE-P150 (manufacturer: Nippon Shokubai Co., Ltd.)
Carbon black (product name: Thermax Floform N990, manufacturer: Cancarb Limited)
Indium Tin Oxide, Blue (manufacturer: COREFRONT)
ZnO-S05 (manufacturer: Sumitomo Osaka Cement Co., Ltd.).

### (Density)

The density of the particle was measured according to a pycnometer (liquid phase displacement) method, with the use of butanol as a dispersion solvent.

In addition, the published values from manufacturers of the respective materials and in the database POLYINFO of the National Institute for Materials Science can be referred to for the density and specific gravity of the particle.

For example:
a density of silica particle is 1.8 g/cm³;
a density of magnesium oxide is 3.65 g/cm³;
a density of aluminum oxide is 3.65 g/cm³;
a density of titanium oxide is 4.0 g/cm³;
a density of zinc oxide is 5.6 g/cm³; and
a density of carbon black is 1.8 g/cm³.

TABLE 4

| Electrophotographic photosensitive member No | Coating liquid for surface layer No | S1 + S2 | S1/S2 | L1 | L1/L2 | |
|---|---|---|---|---|---|---|
| Electrophotographic photosensitive member 1 | Coating liquid for surface layer 1 | 85 | 1.0 | 143 | 8.0 | |
| Electrophotographic photosensitive member 2 | Coating liquid for surface layer 2 | 85 | 1.1 | 145 | 3.9 | |
| Electrophotographic photosensitive member 3 | Coating liquid for surface layer 3 | 70 | 2.0 | 50 | 10.0 | |
| Electrophotographic photosensitive member 4 | Coating liquid for surface layer 4 | 70 | 2.0 | 50 | 2.0 | |
| Electrophotographic photosensitive member 5 | Coating liquid for surface layer 5 | 70 | 2.0 | 300 | 10.0 | |
| Electrophotographic photosensitive member 6 | Coating liquid for surface layer 6 | 70 | 2.0 | 300 | 2.0 | |
| Electrophotographic photosensitive member 7 | Coating liquid for surface layer 7 | 70 | 0.8 | 50 | 10.0 | |
| Electrophotographic photosensitive member 8 | Coating liquid for surface layer 8 | 70 | 0.8 | 50 | 2.0 | |
| Electrophotographic photosensitive member 9 | Coating liquid for surface layer 9 | 70 | 0.8 | 300 | 10.0 | |
| Electrophotographic photosensitive member 10 | Coating liquid for surface layer 10 | 70 | 0.8 | 300 | 2.0 | |
| Electrophotographic photosensitive member 11 | Coating liquid for surface layer 11 | 95 | 2.0 | 50 | 10.0 | |
| Electrophotographic photosensitive member 12 | Coating liquid for surface layer 12 | 95 | 2.0 | 50 | 2.0 | |
| Electrophotographic photosensitive member 13 | Coating liquid for surface layer 13 | 95 | 2.0 | 300 | 10.0 | |
| Electrophotographic photosensitive member 14 | Coating liquid for surface layer 14 | 95 | 2.0 | 300 | 2.0 | |
| Electrophotographic photosensitive member 15 | Coating liquid for surface layer 15 | 95 | 0.8 | 50 | 10.0 | |
| Electrophotographic photosensitive member 16 | Coating liquid for surface layer 16 | 95 | 0.8 | 50 | 2.0 | |
| Electrophotographic photosensitive member 17 | Coating liquid for surface layer 17 | 95 | 0.8 | 300 | 10.0 | |
| Electrophotographic photosensitive member 18 | Coating liquid for surface layer 18 | 95 | 0.8 | 300 | 2.0 | |
| Electrophotographic photosensitive member 19 | Coating liquid for surface layer 19 | 85 | 1.3 | 150 | 3.5 | |
| Electrophotographic photosensitive member 20 | Coating liquid for surface layer 20 | 85 | 1.3 | 50 | 10.0 | |
| Electrophotographic photosensitive member 21 | Coating liquid for surface layer 21 | 85 | 1.3 | 50 | 2.0 | |
| Electrophotographic photosensitive member 22 | Coating liquid for surface layer 22 | 85 | 1.4 | 300 | 10.0 | |
| Electrophotographic photosensitive member 23 | Coating liquid for surface layer 23 | 85 | 1.3 | 300 | 2.0 | |
| Electrophotographic photosensitive member 24 | Coating liquid for surface layer 24 | 70 | 0.8 | 180 | 4.5 | |
| Electrophotographic photosensitive member 25 | Coating liquid for surface layer 25 | 70 | 2.0 | 180 | 4.5 | |
| Electrophotographic photosensitive member 26 | Coating liquid for surface layer 26 | 92 | 0.8 | 180 | 4.5 | |
| Electrophotographic photosensitive member 27 | Coating liquid for surface layer 27 | 92 | 2.0 | 181 | 3.4 | |
| Electrophotographic photosensitive member 28 | Coating liquid for surface layer 28 | 80 | 1.5 | 70 | 8.6 | |
| Electrophotographic photosensitive member 29 | Coating liquid for surface layer 29 | 84 | 1.5 | 150 | 2.7 | |
| Electrophotographic photosensitive member 30 | Coating liquid for surface layer 30 | 84 | 1.0 | 250 | 8.8 | |
| Electrophotographic photosensitive member 31 | Coating liquid for surface layer 31 | 85 | 1.1 | 71 | 6.2 | |
| Electrophotographic photosensitive member 32 | Coating liquid for surface layer 32 | 80 | 0.8 | 60 | 7.4 | |
| Electrophotographic photosensitive member 33 | Coating liquid for surface layer 33 | 80 | 2.0 | 50 | 6.2 | |
| Electrophotographic photosensitive member 34 | Coating liquid for surface layer 34 | 79 | 1.0 | 187 | 2.8 | |
| Electrophotographic photosensitive member 35 | Coating liquid for surface layer 35 | 85 | 1.1 | 252 | 4.3 | |
| Electrophotographic photosensitive member 36 | Coating liquid for surface layer 36 | 85 | 1.9 | 250 | 2.5 | |
| Electrophotographic photosensitive member 37 | Coating liquid for surface layer 37 | 88 | 1.8 | 121 | 2.2 | |
| Electrophotographic photosensitive member 38 | Coating liquid for surface layer 38 | 80 | 1.4 | 60 | 5.0 | |
| Electrophotographic photosensitive member 39 | Coating liquid for surface layer 39 | 89 | 1.8 | 121 | 2.2 | |
| Electrophotographic photosensitive member 40 | Coating liquid for surface layer 40 | 80 | 1.0 | 143 | 8.0 | |
| Electrophotographic photosensitive member 41 | Coating liquid for surface layer 41 | 80 | 1.0 | 143 | 8.0 | |
| Electrophotographic photosensitive member 42 | Coating liquid for surface layer 42 | 80 | 1.0 | 143 | 8.0 | |
| Electrophotographic photosensitive member 43 | Coating liquid for surface layer 43 | 80 | 1.0 | 143 | 8.0 | |
| Electrophotographic photosensitive member 44 | Coating liquid for surface layer 44 | 80 | 1.0 | 143 | 8.0 | |
| Electrophotographic photosensitive member 45 | Coating liquid for surface layer 45 | 80 | 1.0 | 143 | 8.0 | |
| Electrophotographic photosensitive member 46 | Coating liquid for surface layer 46 | 80 | 1.2 | 60 | 5.0 | |
| Electrophotographic photosensitive member 47 | Coating liquid for surface layer 47 | 85 | 1.3 | 180 | 10 | |
| Electrophotographic photosensitive member 48 | Coating liquid for surface layer 48 | 85 | 2.0 | 180 | 2.0 | |
| Electrophotographic photosensitive member 49 | Coating liquid for surface layer 49 | 85 | 2.0 | 180 | 7.0 | |
| Electrophotographic photosensitive member 50 | Coating liquid for surface layer 50 | 85 | 1.5 | 145 | 3.9 | |
| Electrophotographic photosensitive member 51 | Coating liquid for surface layer 51 | 75 | 1.5 | 160 | 6.0 | |
| Electrophotographic photosensitive member 52 | Coating liquid for surface layer 52 | 93 | 1.5 | 124 | 2.6 | |
| | | | | | | Nb concentration/ |
| | | | | | | Ti concentration at |
| | | | | | | inside of 5% of primary |
| | | | | | | particle diameter |
| | | | | | | from surface |
| | | | | | | of first particle, |
| | | | | | | with respect |
| | | | | | | to Nb concentration/ |
| | | | | | | Ti concentration at |
| | | | | | | center portion |
| Electrophotographic photosensitive member No | D1 | D2 | D1/D2 | T1 | T1/D1 | of first particle |
| Electrophotographic photosensitive member 1 | 200 | 80 | 2.5 | 276 | 1.4 | 7.7 |
| Electrophotographic photosensitive member 2 | 220 | 80 | 2.8 | 261 | 1.2 | 7.7 |
| Electrophotographic photosensitive member 3 | 100 | 10 | 10.0 | 117 | 1.2 | 7.7 |
| Electrophotographic photosensitive member 4 | 100 | 30 | 3.3 | 108 | 1.1 | 7.7 |
| Electrophotographic photosensitive member 5 | 350 | 30 | 11.7 | 355 | 1.0 | 7.7 |
| Electrophotographic photosensitive member 6 | 450 | 110 | 4.1 | 446 | 1.0 | 7.7 |
| Electrophotographic photosensitive member 7 | 100 | 10 | 10.0 | 117 | 1.2 | 7.7 |
| Electrophotographic photosensitive member 8 | 100 | 30 | 3.3 | 109 | 1.1 | 7.7 |
| Electrophotographic photosensitive member 9 | 350 | 30 | 11.7 | 424 | 1.2 | 7.7 |
| Electrophotographic photosensitive member 10 | 450 | 110 | 4.1 | 446 | 1.0 | 7.7 |
| Electrophotographic photosensitive member 11 | 100 | 10 | 10.0 | 131 | 1.3 | 7.7 |
| Electrophotographic photosensitive member 12 | 100 | 30 | 3.3 | 120 | 1.2 | 7.7 |
| Electrophotographic photosensitive member 13 | 350 | 30 | 11.7 | 407 | 1.2 | 7.7 |
| Electrophotographic photosensitive member 14 | 450 | 110 | 4.1 | 507 | 1.1 | 7.7 |
| Electrophotographic photosensitive member 15 | 100 | 10 | 10.0 | 131 | 1.3 | 7.7 |
| Electrophotographic photosensitive member 16 | 100 | 30 | 3.3 | 119 | 1.2 | 7.7 |
| Electrophotographic photosensitive member 17 | 350 | 30 | 11.7 | 406 | 1.2 | 7.7 |
| Electrophotographic photosensitive member 18 | 450 | 110 | 4.1 | 508 | 1.1 | 7.7 |
| Electrophotographic photosensitive member 19 | 250 | 80 | 3.1 | 311 | 1.2 | 7.7 |
| Electrophotographic photosensitive member 20 | 100 | 150 | 0.7 | 132 | 1.3 | 7.7 |
| Electrophotographic photosensitive member 21 | 100 | 150 | 0.7 | 122 | 1.2 | 7.7 |
| Electrophotographic photosensitive member 22 | 350 | 30 | 11.7 | 416 | 1.2 | 7.7 |
| Electrophotographic photosensitive member 23 | 450 | 110 | 4.1 | 523 | 1.2 | 7.7 |
| Electrophotographic photosensitive member 24 | 250 | 80 | 3.1 | 317 | 1.3 | 7.7 |
| Electrophotographic photosensitive member 25 | 250 | 80 | 3.1 | 317 | 1.3 | 7.7 |
| Electrophotographic photosensitive member 26 | 250 | 80 | 3.1 | 297 | 1.2 | 7.7 |
| Electrophotographic photosensitive member 27 | 250 | 80 | 3.1 | 295 | 1.2 | 7.7 |
| Electrophotographic photosensitive member 28 | 100 | 30 | 3.3 | 129 | 1.3 | 7.7 |
| Electrophotographic photosensitive member 29 | 250 | 110 | 2.3 | 294 | 1.2 | 7.7 |
| Electrophotographic photosensitive member 30 | 350 | 110 | 3.2 | 411 | 1.2 | 7.7 |
| Electrophotographic photosensitive member 31 | 100 | 30 | 3.3 | 121 | 1.2 | 7.7 |
| Electrophotographic photosensitive member 32 | 100 | 30 | 3.3 | 129 | 1.3 | 7.7 |
| Electrophotographic photosensitive member 33 | 100 | 30 | 3.3 | 129 | 1.3 | 7.7 |
| Electrophotographic photosensitive member 34 | 350 | 170 | 2.1 | 445 | 1.3 | 7.7 |
| Electrophotographic photosensitive member 35 | 350 | 110 | 3.2 | 408 | 1.2 | 7.7 |
| Electrophotographic photosensitive member 36 | 400 | 170 | 2.4 | 464 | 1.2 | 7.7 |
| Electrophotographic photosensitive member 37 | 250 | 110 | 2.3 | 304 | 1.2 | - |
| Electrophotographic photosensitive member 38 | 70 | 10 | 7.0 | 79 | 1.1 | - |
| Electrophotographic photosensitive member 39 | 250 | 110 | 2.3 | 382 | 1.5 | - |
| Electrophotographic photosensitive member 40 | 200 | 80 | 2.5 | 236 | 1.2 | 7.7 |
| Electrophotographic photosensitive member 41 | 200 | 80 | 2.5 | 236 | 1.2 | 3.8 |
| Electrophotographic photosensitive member 42 | 200 | 80 | 2.5 | 236 | 1.2 | 1.8 |
| Electrophotographic photosensitive member 43 | 200 | 80 | 2.5 | 236 | 1.2 | 16 |
| Electrophotographic photosensitive member 44 | 200 | 80 | 2.5 | 236 | 1.2 | 7.7 |
| Electrophotographic photosensitive member 45 | 200 | 80 | 2.5 | 236 | 1.2 | 7.7 |
| Electrophotographic photosensitive member 46 | 70 | 10 | 7.0 | 74 | 1.1 | 7.7 |
| Electrophotographic photosensitive member 47 | 250 | 80 | 3.1 | 251 | 1.0 | 7.7 |
| Electrophotographic photosensitive member 48 | 350 | 170 | 2.1 | 700 | 2.0 | 7.7 |
| Electrophotographic photosensitive member 49 | 300 | 170 | 1.8 | 440 | 1.5 | 7.7 |
| Electrophotographic photosensitive member 50 | 220 | 80 | 2.8 | 300 | 1.4 | 7.7 |
| Electrophotographic photosensitive member 51 | 220 | 80 | 2.8 | 300 | 1.4 | 7.7 |
| Electrophotographic photosensitive member 52 | 220 | 80 | 2.8 | 300 | 1.4 | 7.7 |

### Comparative Example

Comparative Examples were prepared by operations of: producing the layers up to the charge transporting layer in the same way as in the Production Example of the electrophotographic photosensitive member 1; and changing the materials of the coating liquids C1 to C18 for the surface layers to be used for producing the surface layers, respectively, as shown in Table 5. The electrophotographic photosensitive members C1 to C18 were produced in the same way as in the electrophotographic photosensitive member 1, with the use of the prepared coating liquids for the surface layers, respectively. In other words, the electrophotographic photosensitive members C1 to C18 were produced in the same way as the electrophotographic photosensitive member 1, with the use of the coating liquids C1 to C18 for the surface layers, respectively. The results are shown in Table 6. In Table 6, in the EDS analysis of the niobium-doped titanium oxide particle by a scanning transmission electron microscope (STEM), the concentration ratio calculated by niobium atom concentration/titanium atom concentration in the inside of 5% of the primary particle diameter of the niobium-doped titanium oxide particle from the surface of the niobium-doped titanium oxide particle, to the concentration ratio calculated by niobium atom concentration/titanium atom concentration in the center portion of the niobium-doped titanium oxide particle was described as “Nb concentration/Ti concentration in the inside of 5% of the primary particle diameter from the surface of the first particle to Nb concentration/Ti concentration at the center portion of the first particle”.

TABLE 5

| | First particle | | | Second particle | | |
|---|---|---|---|---|---|---|
| | | | Amount | | | Amount |
| Coating liquid for | | | [parts | | | [parts |
| surface layer No | Type | R1[Ω · cm] | by mass] | Type | R2[Ω · cm] | by mass] |
| Coating liquid for | Electroconductive | 1.20 × 10⁵ | 8.60 | QSG-30 | 1.00 × 10¹⁵ | 3.69 |
| surface layer C1 | particle 8 | | | | | |
| Coating liquid for | Electroconductive | 1.10 × 10⁵ | 8.64 | QSG-30 | 1.00 × 10¹⁵ | 3.67 |
| surface layer C2 | particle 9 | | | | | |
| Coating liquid for | Electroconductive | 1.00 × 10⁵ | 8.19 | QSG-100 | 1.00 × 10¹⁵ | 2.79 |
| surface layer C3 | particle 10 | | | | | |
| Coating liquid for | Electroconductive | 1.20 × 10⁵ | 3.41 | KE-P30 | 1.00 × 10¹⁵ | 1.16 |
| surface layer C4 | particle 8 | | | | | |
| Coating liquid for | Electroconductive | 2.09 × 10⁵ | 8.19 | QSG-80 | 1.00 × 10¹⁵ | 2.79 |
| surface layer C5 | particle 4 | | | | | |
| Coating liquid for | Electroconductive | 2.46 × 10⁵ | 8.19 | QSG-30 | 1.00 × 10¹⁵ | 2.79 |
| surface layer C6 | particle 3 | | | | | |
| Coating liquid for | Electroconductive | 2.46 × 10⁵ | 8.19 | QSG-80 | 1.00 × 10¹⁵ | 2.79 |
| surface layer C7 | particle 3 | | | | | |
| Coating liquid for | Electroconductive | 1.77 × 10⁵ | 8.19 | QSG-80 | 1.00 × 10¹⁵ | 2.79 |
| surface layer C8 | particle 5 | | | | | |
| Coating liquid for | Electroconductive | 1.28 × 10⁵ | 2.40 | QSG-80 | 1.00 × 10¹⁵ | 1.35 |
| surface layer C9 | particle 7 | | | | | |
| Coating liquid for | Electroconductive | 1.28 × 10⁵ | 3.20 | QSG-80 | 1.00 × 10¹⁵ | 2.88 |
| surface layer C10 | particle 7 | | | | | |
| Coating liquid for | Electroconductive | 1.28 × 10⁵ | 4.80 | QSG-80 | 1.00 × 10¹⁵ | 1.08 |
| surface layer C11 | particle 7 | | | | | |
| Coating liquid for | Electroconductive | 1.28 × 10⁵ | 6.86 | QSG-80 | 1.00 × 10¹⁵ | 1.23 |
| surface layer C12 | particle 7 | | | | | |
| Coating liquid for | Electroconductive | 1.28 × 10⁵ | 11.92 | QSG-80 | 1.00 × 10¹⁵ | 7.06 |
| surface layer C13 | particle 7 | | | | | |
| Coating liquid for | Electroconductive | 1.28 × 10⁵ | 8.00 | QSG-80 | 1.00 × 10¹⁵ | 7.20 |
| surface layer C14 | particle 7 | | | | | |
| Coating liquid for | Electroconductive | 1.28 × 10⁵ | 17.14 | QSG-80 | 1.00 × 10¹⁵ | 3.09 |
| surface layer C15 | particle 7 | | | | | |
| Coating liquid for | Electroconductive | 1.28 × 10⁵ | 18.24 | QSG-80 | 1.00 × 10¹⁵ | 4.21 |
| surface layer C16 | particle 7 | | | | | |
| Coating liquid for | Electroconductive | 1.28 × 10⁵ | 8.40 | - | - | - |
| surface layer C17 | particle 7 | | | | | |
| Coating liquid for | Electroconductive | 1.28 × 10⁵ | 6.40 | Electroconductive | 3.40 × 10⁵ | 3.20 |
| surface layer C18 | particle 7 | | | particle 2 | | |

| | Amount of | Amount of solvent | |
|---|---|---|---|
| Coating liquid for | binder resin | [parts by mass] | |
| surface layer No | [parts by mass] | 1-Propanol | Cyclohexane |
| Coating liquid for | 3.60 | 118 | 118 |
| surface layer C1 | | | |
| Coating liquid for | 3.60 | 151 | 151 |
| surface layer C2 | | | |
| Coating liquid for | 3.60 | 155 | 155 |
| surface layer C3 | | | |
| Coating liquid for | 3.60 | 70 | 70 |
| surface layer C4 | | | |
| Coating liquid for | 3.60 | 72 | 72 |
| surface layer C5 | | | |
| Coating liquid for | 3.60 | 81 | 81 |
| surface layer C6 | | | |
| Coating liquid for | 3.60 | 81 | 81 |
| surface layer C7 | | | |
| Coating liquid for | 3.60 | 100 | 100 |
| surface layer C8 | | | |
| Coating liquid for | 3.60 | 70 | 70 |
| surface layer C9 | | | |
| Coating liquid for | 3.60 | 66 | 66 |
| surface layer C10 | | | |
| Coating liquid for | 3.60 | 64 | 64 |
| surface layer C11 | | | |
| Coating liquid for | 3.60 | 80 | 80 |
| surface layer C12 | | | |
| Coating liquid for | 3.60 | 155 | 155 |
| surface layer C13 | | | |
| Coating liquid for | 3.60 | 129 | 129 |
| surface layer C14 | | | |
| Coating liquid for | 3.60 | 171 | 171 |
| surface layer C15 | | | |
| Coating liquid for | 3.60 | 200 | 200 |
| surface layer C16 | | | |
| Coating liquid for | 3.60 | 98 | 98 |
| surface layer C17 | | | |
| Coating liquid for | 3.60 | 93 | 93 |
| surface layer C18 | | | |

TABLE 6

| Electrophotographic photosensitive member No | Coating liquid for surface layer No | S1 + S2 | S1/S2 | L1 | L1/L2 | |
|---|---|---|---|---|---|---|
| Electrophotographic photosensitive member C1 | Coating liquid for surface layer C1 | 83 | 1.1 | 300 | 13.0 | |
| Electrophotographic photosensitive member C2 | Coating liquid for surface layer C2 | 78 | 1.1 | 330 | 10.0 | |
| Electrophotographic photosensitive member C3 | Coating liquid for surface layer C3 | 85 | 1.3 | 330 | 2.0 | |
| Electrophotographic photosensitive member C4 | Coating liquid for surface layer C4 | 68 | 1.3 | 300 | 1.2 | |
| Electrophotographic photosensitive member C5 | Coating liquid for surface layer C5 | 85 | 1.5 | 20 | 10.0 | |
| Electrophotographic photosensitive member C6 | Coating liquid for surface layer C6 | 85 | 1.4 | 50 | 13.0 | |
| Electrophotographic photosensitive member C7 | Coating liquid for surface layer C7 | 85 | 1.4 | 20 | 2.0 | |
| Electrophotographic photosensitive member C8 | Coating liquid for surface layer C8 | 85 | 1.3 | 50 | 1.2 | |
| Electrophotographic photosensitive member C9 | Coating liquid for surface layer C9 | 65 | 0.8 | 180 | 4.5 | |
| Electrophotographic photosensitive member C10 | Coating liquid for surface layer C10 | 70 | 0.5 | 180 | 4.5 | |
| Electrophotographic photosensitive member C11 | Coating liquid for surface layer C11 | 63 | 2.0 | 180 | 4.5 | |
| Electrophotographic photosensitive member C12 | Coating liquid for surface layer C12 | 70 | 2.5 | 180 | 4.5 | |
| Electrophotographic photosensitive member C13 | Coating liquid for surface layer C13 | 97 | 0.8 | 180 | 4.5 | |
| Electrophotographic photosensitive member C14 | Coating liquid for surface layer C14 | 93 | 0.7 | 180 | 4.5 | |
| Electrophotographic photosensitive member C15 | Coating liquid for surface layer C15 | 92 | 2.4 | 181 | 3.4 | |
| Electrophotographic photosensitive member C16 | Coating liquid for surface layer C16 | 97 | 2.0 | 185 | 3.0 | |
| Electrophotographic photosensitive member C17 | Coating liquid for surface layer C17 | 50 | - | 230 | - | |
| Electrophotographic photosensitive member C18 | Coating liquid for surface layer C18 | 70 | 2.0 | 180 | 4.5 | |
| | | | | | | Nb concentratio/Ti |
| | | | | | | concentration at inside of 5% of |
| | | | | | | primary particle diameter from |
| | | | | | | surface of first particle, with |
| | | | | | | respect to Nb concentration/Ti |
| | | | | | | concentration at center portion |
| Electrophotographic photosensitive member No | D1 | D2 | D1/D2 | T1 | T1/D1 | of first particle |
| Electrophotographic photosensitive member C1 | 350 | 30 | 11.7 | 410 | 1.2 | 7.7 |
| Electrophotographic photosensitive member C2 | 400 | 30 | 13.3 | 420 | 1.0 | 7.7 |
| Electrophotographic photosensitive member C3 | 450 | 110 | 4.1 | 450 | 1.0 | 7.7 |
| Electrophotographic photosensitive member C4 | 350 | 300 | 1.2 | 383 | 1.1 | 7.7 |
| Electrophotographic photosensitive member C5 | 120 | 150 | 0.8 | 174 | 1.4 | 7.7 |
| Electrophotographic photosensitive member C6 | 100 | 150 | 0.7 | 136 | 1.4 | 7.7 |
| Electrophotographic photosensitive member C7 | 100 | 150 | 0.7 | 136 | 1.4 | 7.7 |
| Electrophotographic photosensitive member C8 | 150 | 150 | 1.0 | 183 | 1.2 | 7.7 |
| Electrophotographic photosensitive member C9 | 250 | 80 | 3.1 | 261 | 1.0 | 7.7 |
| Electrophotographic photosensitive member C10 | 250 | 80 | 3.1 | 305 | 1.2 | 7.7 |
| Electrophotographic photosensitive member C11 | 250 | 80 | 3.1 | 307 | 1.2 | 7.7 |
| Electrophotographic photosensitive member C12 | 250 | 80 | 3.1 | 305 | 1.2 | 7.7 |
| Electrophotographic photosensitive member C13 | 250 | 80 | 3.1 | 305 | 1.2 | 7.7 |
| Electrophotographic photosensitive member C14 | 250 | 80 | 3.1 | 305 | 1.2 | 7.7 |
| Electrophotographic photosensitive member C15 | 250 | 80 | 3.1 | 298 | 1.2 | 7.7 |
| Electrophotographic photosensitive member C16 | 250 | 80 | 3.1 | 288 | 1.2 | 7.7 |
| Electrophotographic photosensitive member C17 | 250 | - | - | 280 | 1.1 | 7.7 |
| Electrophotographic photosensitive member C18 | 250 | 80 | 3.1 | 250 | 1.0 | 7.7 |

### [Evaluation Method]

### <Measurement of Ratio S1 of Area Occupied by First Particles and Ratio S2 of Area Occupied by Second Particles to Total Area in Top Plan View of Surface Layer>

An electrophotographic photosensitive member having a total length of 257.5 mm in the longitudinal direction was cut into a sample piece having 5 mm in each of four directions, with a tool such as a saw. At this time, the sample pieces each having 5 mm in each of four directions were cut out in total of 12 positions which are a position of 38 mm, a position of 128 mm and a position of 218 mm from one end in the longitudinal direction, at every 900 in the circumferential direction. The sample piece was fixed to a sample holder so that the surface layer of the sample piece could be observed. The sample holder to which the sample piece was fixed was subjected to surface observation with the use of a scanning electron microscope (hereinafter, also referred to as “SEM”, product name: JSM7800F, manufacturer: JEOL Ltd.). The surface image of the surface of the electrophotographic photosensitive member obtained by the SEM was subjected to image processing, and the total area of the insulating particle portions and the total area of the electroconductive particle portions based on the observed total area were determined as s1 [%] and s2 [%], respectively. The electroconductive particle and the insulating particle were distinguished from each other with the use of an SEM-EDX function. The previously described operation was performed on the 12 sample pieces, the s1 and the s2 of each sample piece were obtained, and an arithmetic average of the s1 of the 12 sample pieces was represented by S1 of the electrophotographic photosensitive member, and an arithmetic average of the s2 of the 12 sample pieces was represented by S2 of the electrophotographic photosensitive member.

### <Measurement of Exposure Height L1 of First Particle and Exposure Height L2 of Second Particle>

The L1 and the L2 were determined by FIBSEM observation in the following way.

An electrophotographic photosensitive member having a total length of 257.5 mm in the longitudinal direction was cut into a sample piece having 5 mm in each of four directions, with a tool such as a saw. At this time, the sample pieces each having 5 mm in each of four directions were cut out in total of 12 positions which are a position of 38 mm, a position of 128 mm and a position of 218 mm from one end in the longitudinal direction, at every 900 in the circumferential direction. The sample piece was fixed to a sample holder so that the surface layer of the sample piece could be observed. The sample holder to which the sample piece was fixed was subjected to cross-sectional observation with the use of FIBSEM (product name: Nvision, manufacturer: Carl Zeiss Co., Ltd.). The measurement conditions will be described later. In the cross-sectional image of the surface layer of the electrophotographic photosensitive member, which was obtained by the FIBSEM, the first particles were numbered from the left side of the image in order from 1.

A straight line A1 and a straight line B1 were drawn which were in contact with the ends of the first particle of No. 1, respectively, and were orthogonal to the lower layer interface. The straight line A1 and the straight line B1 are straight lines that are orthogonal to the lower layer interface and are parallel to each other, and the straight line A1 is necessarily located on the left side of the straight line B1. This operation was performed on all the first particles that existed in the cross-sectional image and of which the entire images were included in the cross-sectional image. Then, the intersection of the straight line A1 and the lower layer interface was represented by a1, the intersection of the straight line A2 and the lower layer interface was represented by a2, and the length of the straight line connecting the intersection a1 and the intersection a2 was determined as a unit measuring range C1. The unit measuring range was determined for all the straight lines AX (X=1, 2, 3, . . . ), and the unit measuring ranges were represented by CX (X=1, 2, 3, . . . ), respectively. In each of unit measuring ranges CX, the longest straight line orthogonal to the lower layer interface and intersecting boundary line of the surface of the surface layer was determined as the film thickness tX (X=1, 2, 3, . . . ) of the unit measuring range CX, and the shortest straight line was determined as the concave part vX (X=1, 2, 3, . . . ) of the unit measuring range CX.

Furthermore, the longest straight line that was orthogonal to the lower layer interface and intersected with the boundary line of the surface of the surface layer, which was formed by the second particle, was determined as a small convex part wX (X=1, 2, 3, . . . ) of the unit measuring range CX. The difference between the length of the straight line tX and the length of the straight line vX was determined as the exposure height l1-X (X=1, 2, 3, . . . ) of the first particle, and the difference between the length of the straight line wX and the length of the straight line vX was determined as the exposure height l2-X (X=1, 2, 3, . . . ) of the second particle. The arithmetic average value of the obtained exposure heights l1 of the first particles was set as the average exposure height of the first particles of the cross-sectional image, the arithmetic average value of the exposure heights l2 of the second particles was set as the average exposure height of the second particles of the cross-sectional image, and the values obtained by further arithmetically averaging the exposure heights l1 and the exposure heights l2 of each of the 12 sample pieces were respectively determined as the exposure height L1 of the first particles and the exposure height L2 of the second particles of the surface layer of the electrophotographic photosensitive member.

The measurement conditions of the FIBSEM are as follows.

A portion of 2 μm×2 μm×2 μm of the surface layer was converted to 3D, by Slice & View of FIB-SEM.

The conditions of Slice & View were set in the following way.
Processing of sample for analysis: FIB method
Processing and observation apparatus: NVision40 manufactured by Seiko Instruments Inc. and Carl Zeiss Co., Ltd.
Slice interval: 10 nm

### (Observation Conditions)

Acceleration voltage: 1.0 kV
Sample inclination: 54°
WD: 5 mm
Detector: BSE detector
Aperture: 60 μm, high current
ABC: ON
Image resolution: 1.25 nm/pixel

In addition, the measurement environments are as follows: temperature: 23 °C, and pressure: 1×10⁻⁴ Pa. For information, Strata400S (sample inclination: 52°) manufactured by KAGAFEI Co., Ltd. can also be used, as the processing and observation apparatus.

An analysis region of length 2 μm×width 2 μm is subjected to the analysis, information on each cross section is integrated, and a volume V of length 2 μm×width 2 μm×thickness 2 μm (8 μm³) on the surface of the surface layer is determined. In addition, the image of each cross section was analyzed with the use of an image processing software (product name: Image-ProPlus, manufacturer: Media Cybernetics Inc.).

In addition, the surface shape was measured with the use of a scanning probe microscope (“JSPM-5200”, manufacturer: JEOL Ltd.), and it was confirmed that the surface shape coincided with the measurement result by FIBSEM. The particles were distinguished according to the measurement position that was marked after the measurement which used a scanning probe microscope, with the use of an EDX function of a scanning electron microscope (product name: JSM7800F, manufacturer: JEOL Ltd.).

### <Measurement of Average Primary Particle Size D1 of First Particles and Average Primary Particle Size D2 of Second Particles>

First, the entire electrophotographic photosensitive member was immersed in methyl ethyl ketone (MEK) in a graduated cylinder and was irradiated with ultrasonic waves, and the resinous layer was peeled off; and then the base substance of the electrophotographic photosensitive member was taken out. Next, an insoluble matter (photosensitive layer and surface layer containing metal oxide particle), which is not dissolved in MEK, was filtered, and was dried in a vacuum dryer. Furthermore, the obtained solid was suspended in a mixed solvent of tetrahydrofuran (THF)/methylal at a volume ratio of 1:1, and after the insoluble matter was filtered, the residue was collected and dried to solid in a vacuum dryer. Due to this operation, the first particles, the second particles and the resin of the surface layer were obtained. Furthermore, the residue was heated to 500 °C in an electric furnace until only the first and second particles remained as a solid, and the first particles and the second particles were collected. In order to secure the amounts of the first particles and the second particles necessary for the measurement, the same treatment was performed on a plurality of electrophotographic photosensitive members.

A part of the collected metal oxide particles was dispersed in isopropanol (IPA), the dispersion liquid was added dropwise onto a grid mesh provided with a support film (product name: Cu150J, manufacturer: JEOL Ltd.), and the first particle and the second particle were observed in a STEM mode of a scanning transmission electron microscope (product name: JEM2800, manufacturer: JEOL Ltd.). The first particle and the second particle were observed at a magnification of 500000 to 1200000 so as to be easily calculated, and STEM images of 100 particles each of the first particles and the second particles were captured. The first particles and the second particles were distinguished from each other with the use of the EDX function of a scanning electron microscope. At this time, the acceleration voltage was set to 200 kV, the probe size was set to 1 nm, and the image size was set to 1024×1024 pixels.

The primary particle diameter was measured with the use of the obtained STEM image and an image processing software “Image-ProPlus (manufacturer: Media Cybernetics Inc.)”. First, a scale bar displayed at a lower part of the STEM image is previously selected with the use of a straight-line tool (Straight Line) of the tool bar. In the state, Set Scale of the Analyze menu is selected, then, a new window is opened, and a pixel distance of the selected straight line is input to the Distance in Pixels column. A value of the scale bar (for example, 100) is input to the column of the Known Distance of the window, a unit of the scale bar (for example, nm) is input into the Unit of Measurement column, and OK is clicked; and then, the scale setting is completed. Next, a straight line was drawn so as to be the maximum diameter of the metal oxide particle, with the use of a straight-line tool, and the particle diameter was calculated. The same operation was performed for 100 metal oxide particles, and the number average value of the obtained values (maximum diameters) was determined as the primary particle diameter of the metal oxide particles.

However, concerning a sample which uses carbon black as the first particle, the average primary particle size of the first particles was measured according to the following method.

An electrophotographic photosensitive member having a total length of 257.5 mm in the longitudinal direction was cut into a sample piece having 5 mm in each of four directions, with a tool such as a saw. At this time, the sample pieces each having 5 mm in each of four directions were cut out in total of 12 positions which are a position of 38 mm, a position of 128 mm and a position of 218 mm from one end in the longitudinal direction, at every 900 in the circumferential direction. The sample piece was fixed to a sample holder so that the surface layer of the sample piece could be observed. The sample holder to which the sample piece was fixed was subjected to cross-sectional observation with the use of FIBSEM (product name: Nvision, manufacturer: Carl Zeiss Co., Ltd.). The measurement conditions are the same as described previously. The particle diameter of the first particle was measured in a cross-sectional image of the surface layer of the electrophotographic photosensitive member obtained by FIBSEM. This operation was performed on all the first particles that existed in the cross-sectional image and of which the entire images were included in the cross-sectional image. An arithmetic average value of the obtained particle diameters of the first particles was determined as the average particle size of the sample piece, and an arithmetic average value of each of average particle sizes of the 12 sample pieces was further calculated, and was determined as the average primary particle size D1 of the first particles in the surface layer of the electrophotographic photosensitive member.

### <Measurements of Powder Resistivity R1 and Powder Resistivity R2>

The first particles were pressure-molded into a pellet-shaped sample for measurement with a pressure of 300 kg/cm², and the powder resistivity R1 was measured with the use of a four-probe resistivity measurement apparatus (product name: Loresta (registered trademark), manufacturer: Mitsubishi Chemical Corporation), with an application voltage of 100 V The powder resistivity R2 of the second particle was also measured in the same way.

### <Measurement of Film Thickness T1>

An electrophotographic photosensitive member having a total length of 257.5 mm in the longitudinal direction was cut into a sample piece having 5 mm in each of four directions, with a tool such as a saw. At this time, the sample pieces each having 5 mm in each of four directions were cut out in total of 12 positions which are a position of 38 mm, a position of 128 mm and a position of 218 mm from one end in the longitudinal direction, at every 900 in the circumferential direction. The sample piece was fixed to a sample holder so that the surface layer of the sample piece could be observed. The sample holder to which the sample piece was fixed was subjected to cross-sectional observation with the use of FIBSEM (product name: Nvision, manufacturer: Carl Zeiss Co., Ltd.). The measurement conditions are the same as described previously.

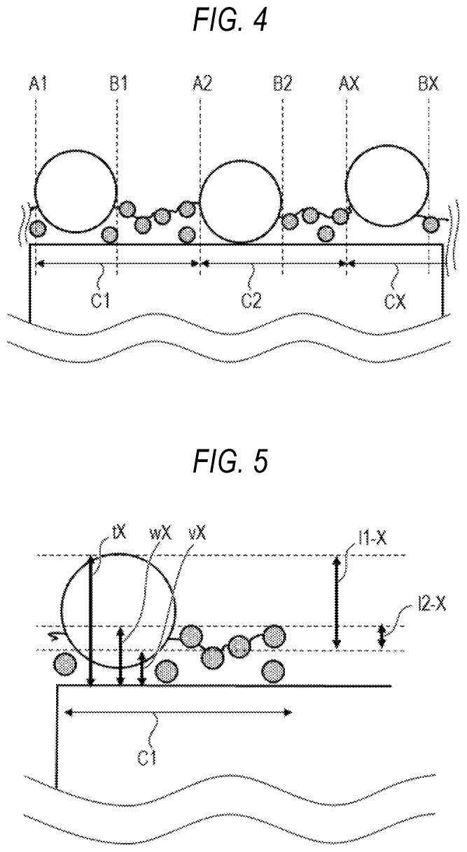

A cross-section of the surface layer of the electrophotographic photosensitive member is illustrated in FIG. 4 and FIG. 5. As in FIG. 4, in the cross-sectional image of the surface layer of the electrophotographic photosensitive member, which was obtained by the FIBSEM, the first particles were numbered from the left side of the image in order from 1. A straight line A1 and a straight line B1 were drawn which were in contact with the ends of the first particle of No. 1, respectively, and were orthogonal to the lower layer interface. The straight line A1 and the straight line B1 are straight lines that are orthogonal to the lower layer interface and are parallel to each other, and the straight line A1 is necessarily located on the left side of the straight line B1. This operation was performed on all the first particles that existed in the cross-sectional image, and of which the entire images were included in the cross-sectional image. Then, the intersection of the straight line A1 and the lower layer interface was represented by a1, the intersection of the straight line A2 and the lower layer interface was represented by a2, and the length of the straight line connecting the intersection a1 and the intersection a2 was determined as a unit measuring range C1. The unit measuring range was determined for all the straight lines AX (X=1, 2, 3, . . . ), and the unit measuring ranges were represented by CX (X=1, 2, 3, . . . ), respectively.

As in FIG. 5, in each of unit measuring ranges CX, the longest line orthogonal to the lower layer interface and intersecting boundary line of the surface of the surface layer was determined as the film thickness tX (X=1, 2, 3, . . . ) of the unit measuring range CX. The arithmetic average value of the obtained film thicknesses tX was determined as the average film thickness of the cross-sectional image, and an arithmetic average value of each of average film thicknesses of the 12 sample pieces was further calculated, and was determined as the film thickness T1 of the surface layer of the electrophotographic photosensitive member.

### <Calculation of Concentration Ratio of Niobium Atom/Titanium Atom in Electroconductive Particle Contained in Electrophotographic Photosensitive Member>

One sample piece having 5 mm in each of four directions was cut out from the electrophotographic photosensitive member, and was cut to the thickness of 200 nm at a cutting speed of 0.6 mm/s by an ultrasonic ultramicrotome (product name: UC7, manufacturer: Leica Camera AG); and a thin sample was prepared. This thin sample was observed at enlarged magnification from 500000 times to 1200000 times with an STEM mode of a scanning transmission electron microscope (product name: JEM2800, manufacturer: JEOL Ltd.), to which an EDS analyzer (energy dispersion type X-rays analyzer) was connected.

Among the cross-sections of the electroconductive particles to be observed, a cross-section of an electroconductive particle having a maximum diameter of about 0.9 times or more and 1.1 times or less of the primary particle diameter was visually selected which was calculated in the above. Subsequently, the constituent element of the cross section of the selected electroconductive particle was collected as a spectrum with the use of an EDS analyzer, and an EDS mapping image was prepared. The collection and analysis of the spectrum were performed with the use of NSS (manufacturer: Thermo Fisher Scientific Inc.). As for the collection conditions, the acceleration voltage was set at 200 kV, the probe size was appropriately selected from 1.0 nm or 1.5 nm so that the dead time became 15 or more and 30 or less, the mapping resolution was set at 256×256, and the number of frames was set at 300. The EDS mapping images were obtained for 100 cross sections of the electroconductive particles.

The ratio of the niobium atom concentration (atom %) to the titanium atom concentration (atom %) in the particle center portion and in the inside of 5% of the maximum diameter of the measured particle from the particle surface is calculated by analysis of the thus obtained EDS mapping images. Specifically, first, a “line extraction” button of the NSS is pressed, a straight line is drawn so as to become the maximum diameter of the particle, and information of the atomic concentration (atom %) on the straight line from one surface to the other surface through the inside of the particle is obtained. When the maximum diameter of the particle obtained at this time was in a range of less than 0.9 times or more than 1.1 times of the primary particle diameter which was calculated in the above, the particle was excluded from the analysis after this. (Only particle having a maximum diameter in the range of 0.9 times or more and less than 1.1 times of the primary particle diameter was submitted to the analysis which would be described below.) Next, the niobium atom concentration (atom %) in the inside of 5% of the maximum diameter of the measured particle from the particle surface is read, on the particle surfaces on both sides. Similarly, “the titanium atom concentration (atom %) in the inside of 5% of the maximum diameter of the measurement particle from the particle surface” is obtained.

Next, with the use of these values, the “concentration ratio of niobium atoms and titanium atoms in the inside of 5% of the maximum diameter of the measured particle from the particle surface” on the particle surface on each of both sides is obtained from the following expression.

Concentration ratio of niobium atoms and titanium atoms in the inside of 5% of the maximum diameter of the measurement particle from the particle surface=(niobium atom concentration (atom %) in the inside of 5% of maximum diameter of measurement particle from particle surface)/(titanium atom concentration (atom %) in the inside of 5% of maximum diameter of measurement particle from particle surface).

A smaller value of obtained two concentration ratios is adopted as the “concentration ratio of niobium atoms to titanium atoms in the inside of 5% of the maximum diameter of the measured particle from the particle surface” in the present disclosure.

In addition, the niobium atom concentration (atom %) and the titanium atom concentration (atom %) are read at the position which is on the above straight line and is the midpoint of the maximum diameter. With the use of these values, the “concentration ratio of niobium atoms to titanium atoms in the particle center portion” is obtained from the following expression.

Concentration ratio of niobium atom to titanium atom in particle center portion=(niobium atom concentration (atom %) in particle center portion)/(titanium atom concentration (atom %) in particle center portion)

For information, the “concentration ratio calculated by niobium atom concentration/titanium atom concentration in the inside of 5% of the maximum diameter of the measured particle from the particle surface, to the concentration ratio calculated by niobium atom concentration/titanium atom concentration in the particle center portion” is calculated by the following expression.

(Concentration ratio of niobium atom and titanium atom in inside of 5% of maximum diameter of measured particle from particle surface)/(concentration ratio of niobium atom and titanium atom in particle center portion)

### <Evaluation of Spot Image>

For the evaluation of the spot image, a modified machine of a laser beam printer (electrophotographic apparatus) (product name: i-SENSYSLBP673Cdw, manufacturer: CANON KABUSHIKI KAISHA) and a toner cartridge were used to which the electrophotographic photosensitive member implemented in the present application was attached. The electrophotographic apparatus was modified so that the voltage applied to the charging roller could be adjusted.

In order to output an evaluation image, firstly, a voltage applied to the charging roller was set so that the surface potential of the electrophotographic photosensitive member became −550 V, and the applied voltage was further adjusted so that the ground current connected to the electrophotographic photosensitive member became constant when the image is formed. First, as an evaluation image at the time of initial use, a halftone image (applied amount of toner: 0.2 mg/cm²) with a margin of 5.0 mm on the top, bottom, left and right was printed on one sheet with cyan. Next, 10000 sheets of 5.0% full color images were printed, and after that, a halftone image similar to the time in the initial use was printed on one sheet as an evaluation image in long-term use. The spot image of the halftone image was evaluated according to the following criteria. The evaluation criteria A to C are levels at which there is no problem in practical use. The evaluation results are shown in Table 7 and Table 8.

### (Evaluation Criteria)

A: a spot image is not observed in the observation for which a loupe is used.

B: a spot image is not observed in the visual observation, but a spot image is slightly observed in some places in the observation for which a loupe is used.

C: a spot image is slightly observed in some places by visual observation.

D: a spot image is observed at a plurality of places by visual observation.

E: a spot image is observed in the entire region of the image by visual observation.

### <Evaluation of Injection Charging Property>

For the measurement of the injection charging property, a modified machine of a laser beam printer (electrophotographic apparatus) (product name: i-SENSYSLBP673Cdw, manufacturer: CANON KABUSHIKI KAISHA) was used. The modified machine used for the evaluation was modified so that the image exposure amount, the amount of an electric current flowing from the charging roller to the support of the electrophotographic photosensitive member (hereinafter, also referred to as total current) and the voltage applied to the charging roller can be each adjusted and measured.

In addition, a process cartridge for a cyan color of the above modified machine was modified, and a potential probe (product name: model 6000B-8, manufacturer: Trek Japan Co., Ltd.) was mounted on the developing position. Next, a surface potential meter (product name: model 344, manufacturer: Trek Japan Co., Ltd.) was set so that the surface potential of the central portion of the electrophotographic photosensitive member could be measured with the use of the surface potential meter.

The electrophotographic photosensitive member was mounted on the modified apparatus under an environment of a temperature of 30 °C and a relative humidity of 80%, then 600 V was applied to the charging roller with a DC current, and the electrophotographic photosensitive member was charged while the electrophotographic photosensitive member was rotated at 60 rpm. The potential of the surface of the electrophotographic photosensitive member at this time was represented by VC, and the injection charge rate (=−VC/600) was calculated. The injection charge rate was ranked in five stages from A to E, according to the values thereof. The evaluation criteria A to C are levels at which there is no problem in practical use. The evaluation results are shown in Table 7 and Table 8.

### (Evaluation Criteria)

A: the injection charge rate is 80% or larger.

B: the injection charge rate is 70% or larger and smaller than 80%.

C: the injection charge rate is 60% or larger and smaller than 70%.

D: the injection charge rate is 50% or larger and smaller than 60%.

E: the injection charge rate is smaller than 50%.

In addition, 10000 sheets were printed in the same way as in the <Evaluation of spot image>; and the injection charge rate of the electrophotographic photosensitive member after long-term use was measured, and the ratio to the initial injection charge rate was described in Table 7 and Table 8 as the injection charge retention property.

### (Evaluation Criteria)

A: the injection charge rate after the endurance with respect to the initial injection charge rate is 80% or larger.

B: the injection charge rate after the endurance with respect to the initial injection charge rate is 70% or larger and smaller than 80%.

C: the injection charge rate after the endurance with respect to the initial injection charge rate is 60% or larger and smaller than 70%.

D: the injection charge rate after the endurance with respect to the initial injection charge rate is 50% or larger and smaller than 60%.

E: the injection charge rate after the endurance with respect to the initial injection charge rate is smaller than 50%.

TABLE 7

| | | | | Injection charge | | |
|---|---|---|---|---|---|---|
| | | Injection charging property | | retention property | | Spot |
| | | Injection charge | | Retention | | image |
| Example No | Electrophotographic photosensitive member No | rate [%] | Rank | rate [%] | Rank | rank |
| Example 1 | Electrophotographic photosensitive member 1 | 80 | A | 92 | A | A |
| Example 2 | Electrophotographic photosensitive member 2 | 82 | A | 90 | A | A |
| Example 3 | Electrophotographic photosensitive member 3 | 93 | A | 60 | C | C |
| Example 4 | Electrophotographic photosensitive member 4 | 93 | A | 60 | C | C |
| Example 5 | Electrophotographic photosensitive member 5 | 93 | A | 60 | C | C |
| Example 6 | Electrophotographic photosensitive member 6 | 93 | A | 60 | C | C |
| Example 7 | Electrophotographic photosensitive member 7 | 64 | C | 60 | C | C |
| Example 8 | Electrophotographic photosensitive member 8 | 64 | C | 60 | C | C |
| Example 9 | Electrophotographic photosensitive member 9 | 65 | C | 60 | C | C |
| Example 10 | Electrophotographic photosensitive member 10 | 65 | C | 60 | C | C |
| Example 11 | Electrophotographic photosensitive member 11 | 96 | A | 60 | C | C |
| Example 12 | Electrophotographic photosensitive member 12 | 96 | A | 60 | C | C |
| Example 13 | Electrophotographic photosensitive member 13 | 96 | A | 60 | C | C |
| Example 14 | Electrophotographic photosensitive member 14 | 96 | A | 60 | C | C |
| Example 15 | Electrophotographic photosensitive member 15 | 75 | B | 60 | C | C |
| Example 16 | Electrophotographic photosensitive member 16 | 75 | B | 60 | C | C |
| Example 17 | Electrophotographic photosensitive member 17 | 76 | B | 60 | C | C |
| Example 18 | Electrophotographic photosensitive member 18 | 76 | B | 60 | C | C |
| Example 19 | Electrophotographic photosensitive member 19 | 89 | A | 90 | A | A |
| Example 20 | Electrophotographic photosensitive member 20 | 88 | A | 60 | C | C |
| Example 21 | Electrophotographic photosensitive member 21 | 88 | A | 60 | C | C |
| Example 22 | Electrophotographic photosensitive member 22 | 90 | A | 60 | C | C |
| Example 23 | Electrophotographic photosensitive member 23 | 89 | A | 60 | C | C |
| Example 24 | Electrophotographic photosensitive member 24 | 64 | C | 60 | C | C |
| Example 25 | Electrophotographic photosensitive member 25 | 93 | A | 60 | C | C |
| Example 26 | Electrophotographic photosensitive member 26 | 74 | B | 78 | B | B |
| Example 27 | Electrophotographic photosensitive member 27 | 95 | A | 74 | B | B |
| Example 28 | Electrophotographic photosensitive member 28 | 90 | A | 74 | B | B |
| Example 29 | Electrophotographic photosensitive member 29 | 92 | A | 88 | A | A |
| Example 30 | Electrophotographic photosensitive member 30 | 80 | A | 80 | A | A |
| Example 31 | Electrophotographic photosensitive member 31 | 84 | A | 74 | B | B |
| Example 32 | Electrophotographic photosensitive member 32 | 69 | C | 67 | C | C |
| Example 33 | Electrophotographic photosensitive member 33 | 94 | A | 60 | C | C |
| Example 34 | Electrophotographic photosensitive member 34 | 78 | B | 88 | A | A |
| Example 35 | Electrophotographic photosensitive member 35 | 84 | A | 80 | A | A |
| Example 36 | Electrophotographic photosensitive member 36 | 94 | A | 80 | A | A |
| Example 37 | Electrophotographic photosensitive member 37 | 95 | A | 75 | B | B |
| Example 38 | Electrophotographic photosensitive member 38 | 94 | A | 60 | C | C |
| Example 39 | Electrophotographic photosensitive member 39 | 90 | A | 75 | B | B |
| Example 40 | Electrophotographic photosensitive member 40 | 72 | B | 88 | A | A |
| Example 41 | Electrophotographic photosensitive member 41 | 66 | C | 88 | A | A |
| Example 42 | Electrophotographic photosensitive member 42 | 78 | B | 88 | A | A |
| Example 43 | Electrophotographic photosensitive member 43 | 78 | B | 88 | A | A |
| Example 44 | Electrophotographic photosensitive member 44 | 78 | B | 88 | A | A |
| Example 45 | Electrophotographic photosensitive member 45 | 78 | B | 88 | A | A |
| Example 46 | Electrophotographic photosensitive member 46 | 86 | A | 67 | C | C |
| Example 47 | Electrophotographic photosensitive member 47 | 89 | A | 60 | C | C |
| Example 48 | Electrophotographic photosensitive member 48 | 95 | A | 60 | C | C |
| Example 49 | Electrophotographic photosensitive member 49 | 95 | A | 74 | B | B |
| Example 50 | Electrophotographic photosensitive member 50 | 92 | A | 88 | A | A |
| Example 51 | Electrophotographic photosensitive member 51 | 89 | A | 81 | A | A |
| Example 52 | Electrophotographic photosensitive member 52 | 93 | A | 76 | B | B |

TABLE 8

| | | Injection charging | | Injection charge | | |
|---|---|---|---|---|---|---|
| | | property | | retention property | | |
| Comparative | Electrophotographic photosensitive | Injection | | Retention | | Spot |
| Example No | member No | charge rate [%] | Rank | rate [%] | Rank | image rank |
| Comparative | Electrophotographic photosensitive | 82 | A | 41 | E | E |
| Example 1 | member C1 | | | | | |
| Comparative | Electrophotographic photosensitive | 78 | B | 46 | E | E |
| Example 2 | member C2 | | | | | |
| Comparative | Electrophotographic photosensitive | 87 | A | 46 | E | E |
| Example 3 | member C3 | | | | | |
| Comparative | Electrophotographic photosensitive | 76 | B | 38 | E | E |
| Example 4 | member C4 | | | | | |
| Comparative | Electrophotographic photosensitive | 85 | A | 33 | E | E |
| Example 5 | member C5 | | | | | |
| Comparative | Electrophotographic photosensitive | 86 | A | 41 | E | E |
| Example 6 | member C6 | | | | | |
| Comparative | Electrophotographic photosensitive | 85 | A | 33 | E | E |
| Example 7 | member C7 | | | | | |
| Comparative | Electrophotographic photosensitive | 86 | A | 38 | E | E |
| Example 8 | member C8 | | | | | |
| Comparative | Electrophotographic photosensitive | 59 | D | 43 | E | E |
| Example 9 | member C9 | | | | | |
| Comparative | Electrophotographic photosensitive | 39 | E | 60 | C | C |
| Example 10 | member C10 | | | | | |
| Comparative | Electrophotographic photosensitive | 89 | A | 40 | E | E |
| Example 11 | member C11 | | | | | |
| Comparative | Electrophotographic photosensitive | 93 | A | 32 | E | E |
| Example 12 | member C12 | | | | | |
| Comparative | Electrophotographic photosensitive | 75 | B | 42 | E | E |
| Example 13 | member C13 | | | | | |
| Comparative | Electrophotographic photosensitive | 59 | D | 76 | B | B |
| Example 14 | member C14 | | | | | |
| Comparative | Electrophotographic photosensitive | 92 | A | 42 | E | E |
| Example 15 | member C15 | | | | | |
| Comparative | Electrophotographic photosensitive | 93 | A | 42 | E | E |
| Example 16 | member C16 | | | | | |
| Comparative | Electrophotographic photosensitive | 92 | A | 34 | E | E |
| Example 17 | member C17 | | | | | |
| Comparative | Electrophotographic photosensitive | 95 | A | 50 | D | D |
| Example 18 | member C18 | | | | | |

According to the present disclosure, an electrophotographic photosensitive member that can withstand use in an image forming apparatus having a long life can be provided by techniques of: using two types of particles in a design of a surface layer of the electrophotographic photosensitive member; and creating an appropriate surface state in the surface layer of the electrophotographic photosensitive member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic photosensitive member having a surface layer, wherein
the surface layer comprises a binder resin, a first particle and a second particle;
the surface of the surface layer has a convex part derived from the first particle and a convex part derived from the second particle;
when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2):
70≤(S1+S2)≤95 (1), and
0.8≤(S1/S2)≤2.0 (2); and
when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy the following expression (3) and the following expression (4):
50≤L1≤300 (3), and
2.0≤L1/L2≤10.0 (4), wherein
the first particle comprises any one or more selected from the group consisting of a metal oxide particle, a metal particle and carbon black, and
the second particle comprises a silica particle.

2. The electrophotographic photosensitive member according to claim 1, wherein when the number-based average primary particle size of the first particle is defined as D1 [nm] and the number-based average primary particle size of the second particle is defined as D2 [nm], the D1 and the D2 satisfy the following expression (5), the following expression (6) and the following expression (7):
100≤1D1≤350 (5),
30≤D2≤150 (6), and
2.0≤D1/D2≤10.0 (7).

3. The electrophotographic photosensitive member according to claim 1, wherein when the film thickness of the surface layer is defined as T1 [nm] and the number-based average primary particle size of the first particle is defined as D1 [nm], the T1 and the D1 satisfy the following expression (8):
1.0≤T1/D1≤1.8 (8).

4. The electrophotographic photosensitive member according to claim 1, wherein
the powder resistivity R1 of the first particle is 1×10⁸ Ω·cm or smaller, and
the powder resistivity R2 of the second particle is 1.0×10¹⁰ Ω·cm or larger.

5. The electrophotographic photosensitive member according to claim 1, wherein the powder resistivity R2 of the second particle is 1.0×10¹³ Ω·cm or larger.

6. The electrophotographic photosensitive member according to claim 1, wherein the first particle comprises any one or more selected from the group consisting of a tin oxide particle, an ITO particle, a titanium oxide particle and a zinc oxide particle.

7. The electrophotographic photosensitive member according to claim 1, wherein
the first particle comprises a titanium oxide particle doped with niobium; and in an EDS analysis of the titanium oxide particle doped with niobium,
which uses a scanning transmission electron microscope (STEM), the concentration ratio calculated by niobium atom concentration/titanium atom concentration in the inside of 5% of a primary particle diameter of the titanium oxide particle doped with niobium from a surface of the titanium oxide particle doped with niobium is 2.0 times or larger with respect to the concentration ratio calculated by niobium atom concentration/titanium atom concentration in a central portion of the titanium oxide particle doped with niobium.

8. A process cartridge that integrally supports an electrophotographic photosensitive member having a surface layer, and at least one unit selected from the group consisting of a charging unit, a developing unit and a cleaning unit, and is freely attachable to and detachable from a main body of an electrophotographic apparatus, wherein
the surface layer comprises a binder resin, a first particle and a second particle;
the surface of the surface layer has a convex part derived from the first particle and a convex part derived from the second particle;
when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2):
70≤(S1+S2)≤95 (1), and
0.8≤(S1/S2)≤2.0 (2);
when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy the following expression (3) and the following expression (4):
50≤L1≤300 (3), and
2.0≤L1/L2≤10.0 (4);
the first particle comprises any one or more selected from the group consisting of a metal oxide particle, a metal particle and carbon black, and
the second particle comprises a silica particle.

9. An electrophotographic apparatus comprising: an electrophotographic photosensitive member having a surface layer, a charging unit, an exposure unit, a developing unit and a transfer unit, wherein
the surface layer comprises a binder resin, a first particle and a second particle;
the surface of the surface layer has a convex part derived from the first particle and a convex part derived from the second particle;
when the ratio of an area occupied by the first particle to the total area of the surface layer is defined as S1[%] and the ratio of an area occupied by the second particle to the total area of the surface layer is defined as S2[%] in a top plan view of the surface layer, the S1 and the S2 satisfy the following expression (1) and the following expression (2):
70≤(S1+S2)≤95 (1), and
0.8≤(S1/S2)≤2.0 (2);
when an exposure height of the first particle exposed on the surface of the electrophotographic photosensitive member is defined as L1 [nm] and an exposure height of the second particle exposed on the surface of the electrophotographic photosensitive member is defined as L2 [nm], the L1 and the L2 satisfy the following expression (3) and the following expression (4):
50≤L1≤300 (3), and
2.0≤L1/L2≤10.0 (4);
the first particle comprises any one or more selected from the group consisting of a metal oxide particle, a metal particle and carbon black, and
the second particle comprises a silica particle.
